(19) United States
(12) Patent Application Publication
(10) Pub. No.: US 2026/0135373 A1
(43) Pub. Date: May 14, 2026

(54) SYSTEM AND METHOD FOR RAPID SHUTDOWN OF SOLAR ARRAY

(71) Applicant: Optivolt Labs, Inc., San Francisco, CA (US)

(72) Inventors: Linda Stacey Irish, San Francisco, CA (US); Jonathan Mullen, San Francisco, CA (US); Amira Ryce, San Francisco, CA (US); Eric Stolt, San Francisco, CA (US); Kevin Rodriguez, San Francisco, CA (US)

(21) Appl. No.: 19/394,792

(22) Filed: Nov. 19, 2025

Related U.S. Application Data
(63) Continuation-in-part of application No. 19/353,545, filed on Oct. 8, 2025.
(60) Provisional application No. 63/704,894, filed on Oct. 8, 2024.
(60) Provisional application No. 63/722,280, filed on Nov. 19, 2024.
(60) Provisional application No. 63/750,618, filed on Jan. 28, 2025.

(51) Int. Cl. H02H 7/20; H02J 3/001; H02J 3/38; H02J 101/24; H04W 12/06; H04W 12/084

(52) U.S. Cl. CPC H02H 7/20; H02J 3/001; H02J 3/38; H04W 12/06; H04W 12/084; H02J 2101/25

(57) ABSTRACT

One variation of a system includes a hub and a module coupled to a solar array. During a first time period: the hub detects nominal operation of the solar array broadcasts a first token accordingly; and the module receives the first token, authenticates the first token; and maintains a switch—coupled to an output terminal of the module—in a closed position to output power from a solar panel to an inverter in response to authentication of the first token. During a second time period: the hub detects deviation of the solar array from nominal operation and withholds broadcast of tokens accordingly; and the module triggers the switch to transition to an open position to cease output of power from the first solar panel to the inverter in response to absence of receipt of a second token broadcast by the hub.

### CROSS-REFERENCE TO RELATED APPLICATIONS

This Application claims the benefit of U.S. Provisional Application No. 63/722,280, filed on 19 Nov. 2024, which is incorporated in its entirety by this reference.

This Application is a continuation-in-part of U.S. patent application Ser. No. 19/353,545, filed on 8 Oct. 2025, which claims the benefit of U.S. Provisional Application No. 63/750,618, filed on 28 Jan. 2025, and 63/704,894, filed on 8 Oct. 2024, each of which is incorporated in its entirety by this reference.

This Application is related to U.S. patent application Ser. No. 18/610,983, filed on 20 Mar. 2024, U.S. patent application Ser. No. 18/129,321, filed on 31 Mar. 2023, and U.S. Provisional Application No. 63/326,121, filed on 31 Mar. 2022, each of which is incorporated in its entirety by this reference.

### TECHNICAL FIELD

This invention relates generally to the field of photovoltaics and, more specifically, to a new and useful system and method for rapid shutdown of solar array in the field of photovoltaics.

### BRIEF DESCRIPTION OF THE FIGURES

FIG. 1 is a flowchart representation of a system and a method; and

FIG. 2 is a graphical representation of one variation of the system;

FIG. 3 is a schematic representation of one variation of the system;

FIG. 4 is a schematic representation of one variation of the system;

FIG. 5 is a flowchart representation of one variation of the method;

FIG. 6 is a flowchart representation of one variation of the method;

FIG. 7 is a flowchart representation of one variation of the method; and

FIG. 8 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Power Regulator Module

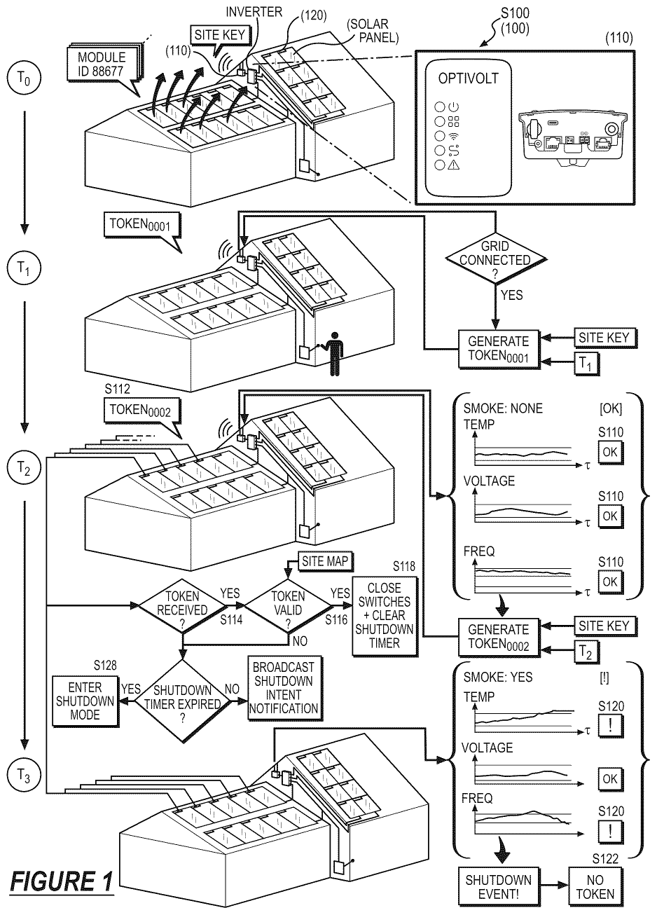

As shown in FIGS. 1, 2, and 3, a system 100 includes a first power regulator module 120.

The first power regulator module 120 is coupled to a first solar panel in a solar array and includes: a first isolation switch 122 operable in a) a closed position to output power from the first solar panel to an inverter and b) an open position to cease output of power from the first solar panel to the inverter; a first wireless communication module 128; and a first local memory 129 configured to store a first site key.

The first power regulator module 120 is configured to, during a first time period: access a first token broadcast by a hub and received by the first wireless communication module 128; authenticate the first token based on the first site key; and maintain the first isolation switch 122 in the closed position to output power from the first solar panel to the inverter in response to authenticating the first token.

The first power regulator module 120 is also configured to, during a second time period: trigger the first isolation switch 122 to transition to the open position to cease output of power from the first solar panel to the inverter in response to absence of receipt of a second token by the first wireless communication module 128.

### 1.1 Hub

As shown in FIGS. 1, 2, and 3, one variation of the system 100 also includes a hub coupled to a solar array.

The hub is configured to, during a first time period: detect nominal operation of the solar array; and broadcast a first token in response to detecting nominal operation of the solar array.

The hub is also configured to, during a second time period: detect deviation of the solar array from nominal operation; and cease broadcast of tokens in response to detecting deviation of the solar array from nominal operation.

### 1.2 Method for Rapid Shutdown Control

As shown in FIGS. 1, 2, and 3, a method S100 includes, at a hub coupled to a solar array, during a first time period: detecting nominal operation of the solar array in Block S110; and broadcasting a first token in Block S112 in response to detecting nominal operation of the solar array.

The method also includes, at a first power regulator module 120 coupled to a first solar panel in the solar array during the first time period: receiving the first token broadcast by the hub in Block S114; authenticating the first token in Block S116; and maintaining a first isolation switch 122, coupled to an output terminal of the first power regulator module 120, in the closed position to output power from the first solar panel to an inverter in Block S118 in response to authenticating the first token.

The method S100 also includes, at the hub during a second time period: detecting deviation of the solar array from nominal operation in Block S120; and withholding broadcast of tokens in response to detecting deviation of the solar array from nominal operation in Block S122.

The method also includes, at the first power regulator module 120 during a second time period: triggering the first isolation switch 122 to transition to the open position to cease output of power from the first solar panel to the inverter in Block S128 in response to absence of receipt of a second token broadcast by the hub.

### 2. Applications

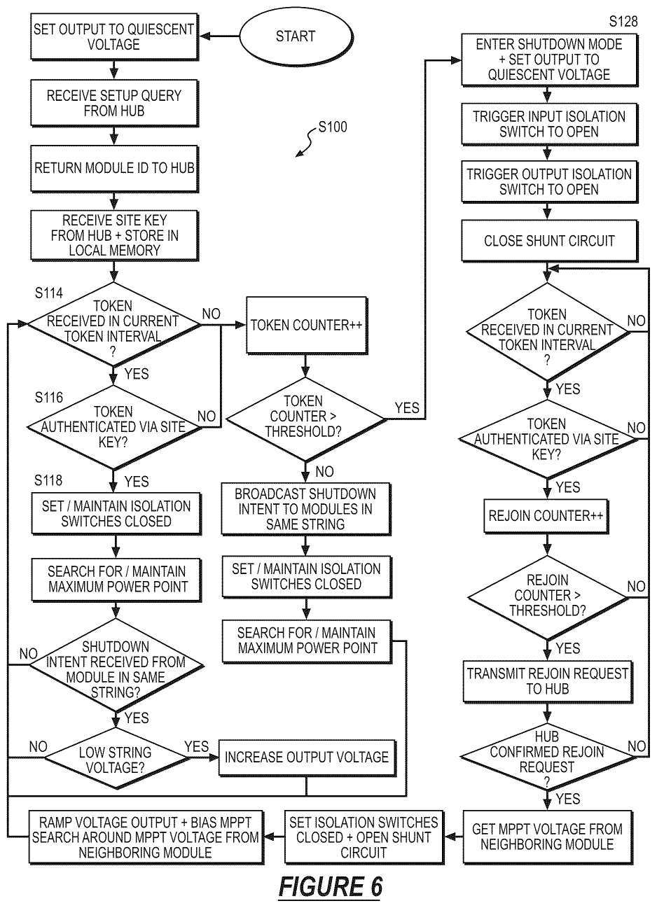

Generally and as shown in FIGS. 1 and 6, the system 100 includes: a set of power regulator modules 120, each integrated into or coupled to a solar panel in a solar array; and a hub integrated into or coupled to an inverter in the solar array. The hub: tracks operation of the solar array—such as inverter input and output voltages, shutdown or enable signals from the inverter, stability of the inverter input and output, indications of smoke or fire, and/or manual activation or deactivation of the solar array—via a suite of connected or integrated sensors; broadcasts tokens (e.g., a rolling code), such as at a predefined frequency (e.g., 1 Hz), while the hub has confirmed valid, normal, or in-bound operation of the solar array based on these sensor data; and ceases broadcast of tokens once the hub detects invalid, abnormal, or out-of-bound operation of the solar array based on these sensor data. Each power regulator module 120 is configured to: receive (or “intercept”) tokens broadcast by the hub; modulate voltage and power output from its corresponding solar panel to the inverter, such as to maintain voltage and power output of the solar panel at or near its maximum power point, for up to a threshold shutdown duration (e.g., ten seconds) since the power regulator module 120 last received a valid token from the hub; and to automatically shut down power output from the solar panel to the inverter responsive to failure to receive a valid token from the hub for more than the threshold shutdown duration.

More specifically, each power regulator module 120 can execute nominal operating processes to control voltage and/or power output of its solar panel for as long as the power regulator module 120 receives valid tokens from the hub. However, once the hub ceases broadcast of valid tokens—such as due to sensed conditions within the solar array or failure of the hub itself—these power regulator modules 120 can automatically shut down. Therefore, each power regulator module 120 can autonomously execute a rapid-shutdown scheme—responsive to absence of receipt of a valid token regardless of the true state of the hub—and isolate its solar panel from the inverter without reliance on centralized communications, commands, or relays.

Thus, the power regulator modules 120 can continue to operate only while: the hub is active; the hub has verified normal or in-bound operation of the solar array; and/or the power regulator module 120 has received and validated a token within the last threshold shutdown duration. Conversely, the power regulator modules 120 can cease to operate if any of: the hub fails (and therefore is not monitoring operation of the solar array); the hub fails to verify normal or in-bound operation of the solar array; or the power regulator module 120 fails to receive and validate a token within the last threshold shutdown duration. Accordingly, the power regulator modules 120 can continue operation only while operation of the solar array is monitored (e.g., by the hub) and while such operation is normal or in-bound. Therefore, the hub and the power regulator modules 120 can cooperate to continuously prove normal or in-bound operation of the solar array through receipt and authentication of successive tokens broadcast by the hub.

Furthermore, each power regulator module 120 can execute an individual, distributed decision to cease its operation (i.e., cease power output, return output to a quiescent voltage) responsive to its own failure to receive or validate a token and without input or voting from other power regulator modules 120, thereby: reducing an attack surface of the solar array (e.g., insofar as no power regulator module 120 influences another power regulator module 120 to maintain operation despite absence of receipt of a valid token); and ensuring that the solar array fails with all power regulator modules 120 inactive (i.e., outputting a null or quiescent voltage) due to absence of receipt of valid tokens.

The hub can also generate unique, time-based and/or sequent-dependent rolling codes (e.g., based on a) a current time and/or preceding token and b) a secret key or cryptographic function) following each confirmed instance of normal or in-bound operation of the solar array. Each power regulator module 120 can store a site key—such as unique to the solar array—and validate each rolling code received from the hub based on this site key, thereby: decreasing risk of spoofed tokens triggering power regulator modules 120 to maintain operation when the hub has failed or detected abnormal operation of the solar array; and thus further reducing the attack surface of the solar array.

Therefore, the hub can broadcast “heartbeats” in the form of tokens (e.g., rolling codes) during periods of confirmed normal operation of the solar array, and power regulator modules 120 can maintain nominal operation with their corresponding solar panels upon individual receipt of valid heartbeats from the hub—and vice versa—thereby: ensuring a failsafe condition of the solar array; securing the solar array against hacking; and decreasing an attack surface of the solar array.

### 2.1 Power Regulator Module Switching and Shunt

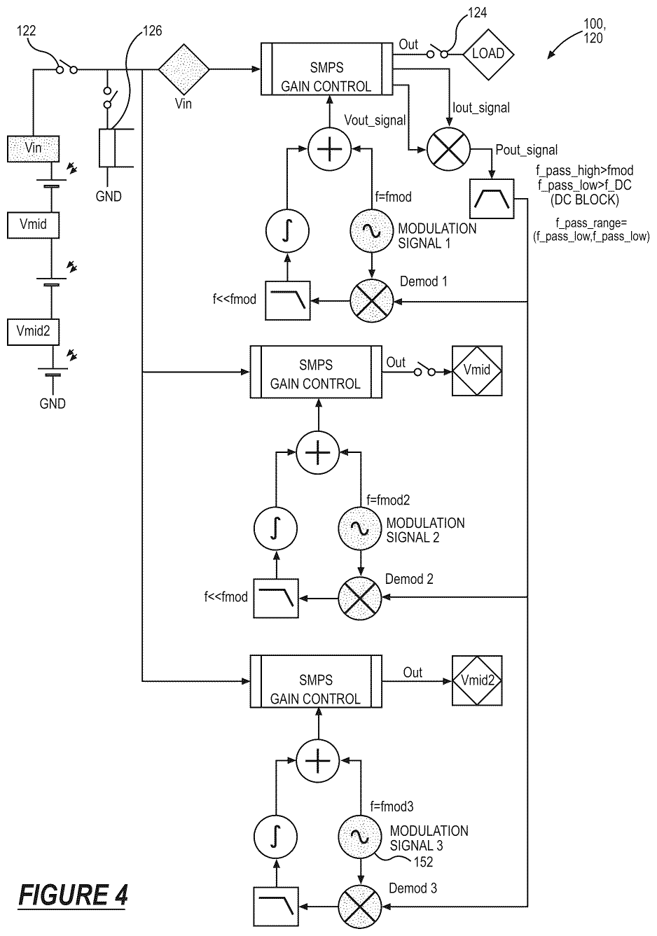

In one example shown in FIG. 4, a power regulator module 120 can include: a regulator circuit that regulates power and voltage output of the solar panel to the inverter; an input isolation switch 122, an output isolation switch 124, and a shunt circuit arranged within. For up to the threshold shutdown duration following receipt of a valid token, the power regulator module 120 can: maintain the input isolation switch 122 and the output isolation switch 124 in their closed positions; and modulate a duty cycle of the regulator circuit in order to track the output of its corresponding solar panel to its maximum power point (or to another target solar panel voltage or string voltage set by the hub). In response to failure to receive a valid token for more than the threshold shutdown duration, the power regulator module 120 can sequentially: open the input isolation switch 122; open the output isolation switch 124; and close the shunt circuit to discharge residual charge in the regulator circuit, collapsing voltage across the output terminals of the power regulator module 120 to a quiescent level.

### 2.2 Disclaimers

The system 100 is described herein as including a hub—including a local controller and located adjacent or integrated into the inverter—in communication with discrete power regulator modules 120—each connected to one solar panel—in a solar array. However, the hub can communicate more generally with solar panels in the solar array or with power regulator modules 120 specifically integrated directly into solar panels.

Furthermore, the system 100 is described herein as including multiple solar panels connected in series to form a set of solar strings, wherein all solar strings in the solar array are connected in parallel to one common solar inverter. Alternatively, the system 100 can include: multiple string-specific hubs; and multiple solar panels connected in series to form a set of solar strings, wherein each solar string is connected to a string-specific micro-inverter and controlled by one string-specific hub.

Furthermore, the system 100 is described herein as including power regulator modules 120 in conventional-buck configurations in which increasing duty cycle increases output voltage. However, the system 100 can additionally or alternatively include power regulator modules 120 in inverted-buck configurations in which decreasing duty cycle increases output voltage.

Furthermore, the system 100 is described herein as including power regulator modules 120 configured to wirelessly communicate directly with other power regulator modules 120, such as via wired or short-range wireless communication protocols. However, the power regulator modules 120 can communicate with other power regulator modules 120 in the solar array via the hub, such as via wired or wireless communication protocols. For example, these power regulator modules 120 can transmit telemetry, status, or other data to the hub, and the hub can transform these data into general or power regulator module-specific commands and distribute these commands to other power regulator modules 120 in the solar array accordingly, such as via wired or wireless communication protocols.

### 3. Terms

Generally, a solar substring herein refers to a subdivision of a solar panel, such as a set of solar cells arranged in series within one solar panel housing.

Generally, a solar panel herein refers to an assembly containing one or more solar cells (e.g., arranged in a solar substring) arranged in a discrete housing.

Generally, a power regulator module 120 herein refers to a power electronics device installed on, installed near, or integrated into a solar panel and configured to control output voltage and/or output power of the solar panel.

Generally, a solar string herein refers to a series-connected group of solar panels whose voltages sum. Solar strings are connected to an inverter, such as in parallel or independently.

Generally, a solar array herein refers to an entire solar installation on a structure (e.g., a roof of a commercial or residential building, a solar panel support structure on a solar farm), including multiple solar strings, each containing one or more solar panels.

### 4. Power Regulator Module

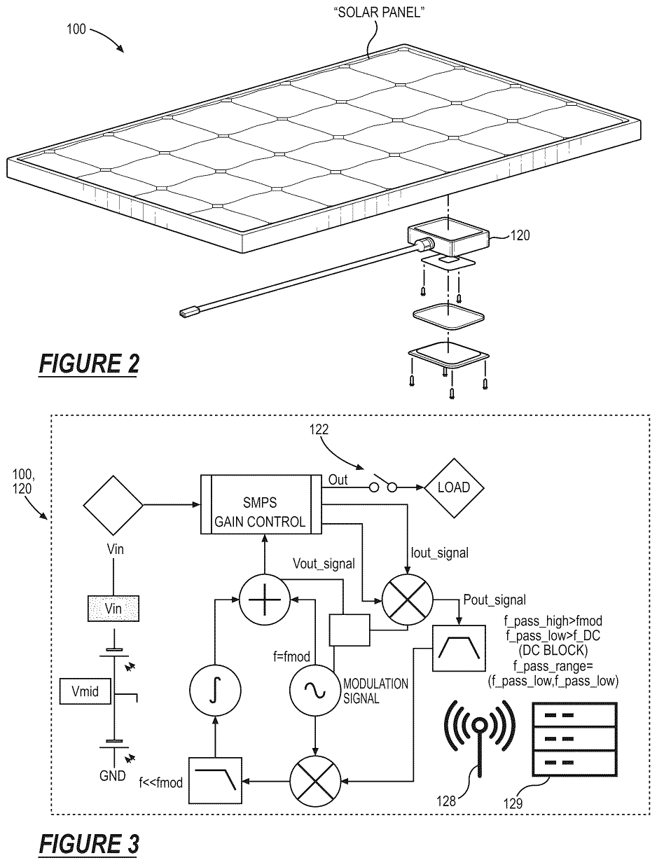

As shown in FIGS. 1 and 2, each solar panel can include or can be coupled to a power regulator module 120.

Generally, a power regulator module 120 can: balance output voltage across solar cells within the solar panel to a nominal output voltage; and adjust (e.g., buck, boost) this nominal output voltage to a target output voltage (e.g., a maximum power point voltage).

In one implementation shown in FIGS. 2-4, a power regulator module 120 defines a self-contained device configured to install on an individual solar panel, such as to a rear face of the solar panel. In this implementation, the power regulator module 120 can include: an enclosure (e.g., polycarbonate, aluminum) configured to install on the rear side of the solar panel, such as via fasteners and/or adhesives; a regulator circuit (e.g., printed circuit board) arranged within the enclosure; and a processor arranged within the enclosure and configured to control operation of the regulator circuit, such as based on internal operation of the power regulator module 120, data (e.g., duty cycles, maximum output voltage, telemetry data) received from other power regulator modules 120 in the solar array, and/or tokens received—or not received—from the hub. Additionally, the regulator circuit can include: a set of input terminals (e.g., multi-contact 4-millimeter input jack, Amphenol H4 input jack) accessible from the enclosure and configured to connect (e.g., via wiring, direct soldering) to output terminals of a solar panel; and a set of output terminals (e.g., multi-contact 4-millimeter output jack, Amphenol H4 output jack) accessible from the enclosure and configured to connect (e.g., via wiring) to additional power regulator modules 120, a solar inverter, or a string inverter.

In particular, the regulator circuit can perform power conversion between the input terminals and the output terminals. As shown in FIGS. 3 and 4, the regulator circuit can include a set of switching elements (e.g., metal-oxide semiconductor field-effect transistors, insulated-gate bipolar transistors), a set of passive components (e.g., inductors, capacitors, transformers), and a control interface coupled to a gate-driver circuit. During operation, the regulator circuit can convert an input voltage received from the solar panel into a regulated output voltage supplied to the inverter (or to other downstream power regulator module 120 connected in series to the power regulator module 120). The regulator circuit can be configured to operate in buck, boost, or buck-boost modes and can support bi-directional current blocking through an input isolation switch 122 and/or an output isolation switch 124, such as during a shutdown resulting from absence of receipt of a valid token from the hub by the power regulator module 120 (i.e., a “shutdown event”).

Accordingly, the regulator circuit can also include an input isolation switch 122 coupled between the input terminals and a regulator circuit of the power supply and an output isolation switch 124 coupled between the regulator circuit and the output terminals. In particular, the power regulator module 120 is configured: to trigger the input isolation switch 122 to open in response to detection of a shutdown event and thus prevent reverse current flow into the solar panel; and to trigger the output isolation switch 124 to open in response to the detection of the shutdown event and thus isolate the regulator circuit from the inverter (or downstream power regulator modules 120). The regulator circuit can further include a shunt circuit configured to discharge residual charge in the regulator circuit following opening of the output isolation switch 124, collapsing voltage across the output terminals to a quiescent level during or after a shutdown event.

The power regulator module 120 can also include a wireless communication module 128 configured: to receive a site key, tokens, and/or control signals transmitted by the hub; to transmit operational data (e.g., duty cycle, maximum power point voltage, telemetry) of the power regulator module 120 and/or its corresponding solar panel to the hub, the solar inverter, and/or other power regulator modules 120; to receive operational data from the elements of the system 100; to broadcast test packets during a string identification period; to receive test packets broadcast by other power regulator modules during a string identification period; to form a mesh network with other power regulator modules 120 in the solar array during nominal operation; and/or to rebroadcast tokens—received from the hub—to other power regulator modules 120 during nominal operation.

The power regulator module 120 can also include a signal processing circuit: electrically coupled to output terminals of the power regulator module 120; and configured to detect and interpret ripples in voltages across these output terminals resulting from output of test signals by other power regulator modules 120 connected to the power regulator module 120. The signal-processing circuit can also detect and report an output voltage across the output terminals of the power regulator module 120. For example, during or after detection of a shutdown event by the power regulator module 120, the signal-processing circuit can detect the output voltage across the output terminals of the power regulator module 120; if this output voltage exceeds a threshold voltage after actuation of the shunt circuit, the power regulator module 120 can generate a shutdown-fault flag indicating incomplete discharge of the regulator circuit in the power regulator module 120.

### 4.1 Integrated Power Regulator Module

In one variation, the power regulator module 120 is fully integrated into the solar panel and is wired directly to power levels (e.g., individual solar cells, solar substrings) within a solar panel.

### 4.2 Power Regulator Module Operation

As shown in FIGS. 3 and 4 and as described in U.S. patent application Ser. No. 18/610,983, filed on 20 Mar. 2024 and which is incorporated herein by reference, a power regulator module 120 can include: a power supply (e.g., a switch-mode power supply) connected to a set of solar cells (e.g., a solar substring) within one solar panel and configured to receive an input voltage generated by the set of solar cells; and a modulation signal generator coupled to a gain control of the power supply and configured to modulate a voltage gain of the input voltage received at the power supply.

During operation of the solar array, the set of solar cells produces an input voltage that is supplied to an input terminal of the power supply. The power regulator module 120 can then adjust a gain control of the power supply (e.g., via duty-cycle adjustment) to regulate a voltage or power output of the power regulator module 120 to a load connected to the power regulator module 120.

The power regulator module 120 can also generate a power signal based on a voltage output and a current output from the power supply. The power regulator module 120 can trigger the modulation signal generator to generate a modulation signal characterized by a particular phase and frequency to modulate the gain control of the power supply and thus control the input voltage at the power supply. Therefore, the gain control of the power supply can remain in alignment with the phase and frequency of the modulation signal during operation of the power regulator module 120 (i.e., when the modulation signal increases in amplitude, the voltage gain is increased, and when the modulation signal decreases in amplitude, the voltage gain is decreased).

The power regulator module 120 can then generate a power signal based on the output voltage and current of the power supply as modulated by the modulation signal. During operation of the power regulator module 120, the power signal output by the power supply can fluctuate (i.e., increase and decrease in amplitude) as the gain control of the power supply is modulated by the modulation signal. The power regulator module 120 can de-modulate this power signal and detect a deviation of the input voltage from a maximum power point voltage based on the DC component of the de-modulated signal, and apply a corrective voltage gain step toward the maximum power point voltage.

In one variation, the power regulator module 120 can apply a band-pass filter to the power signal output by the power supply in order to reduce unwanted noise generated by the power supply. For example, the band-pass filter can define: a high-pass cutoff frequency greater than the frequency of the modulation signal; and a low-pass cutoff frequency less than the frequency of the modulation signal and configured to block a DC component of the power signal.

In one variation, the regulator circuit can also coordinate operation of the power supply with protective switching elements and communication subsystems described above. For example, during normal operation, the power regulator module 120 can maintain the input isolation switch 122 and the output isolation switch 124 in their corresponding closed positions while executing modulation and integration steps described herein. In response to detecting a shutdown event, the power regulator module 120 can: suspend modulation of the power supply; trigger the input isolation switch 122 to open to isolate the solar panel from the power regulator module 120; trigger the output isolation switch 124 to open to disconnect the power regulator module 120 from the inverter; and activate the shunt circuit—coupled to the regulator circuit—to discharge residual charge stored in the regulator circuit, such as in this sequential order with a brief delay (e.g., 20 milliseconds) between the foregoing actions.

### 4.3 De-Modulator: Extracting Direct-Current Signals

Generally, the power regulator module 120 can further include a de-modulator connected to the modulation signal generator and the power supply and configured to generate a de-modulated signal. The power regulator module 120 can input the power signal output from the power supply and the modulation signal output from the modulation signal generator through the de-modulator to then output a de-modulated signal representing a correlation between the power signal and the modulation signal.

In one variation, the de-modulator includes a multiplier circuit configured to apply a product operation to the power signal and the modulation signal to then generate the de-modulated signal. In this variation, the power regulator module 120 can also include a low-pass filter: connected to the de-modulator; defining a cut-off frequency less than the frequency of the modulation signal; and configured to block an AC component of the de-modulated signal. The power regulator module 120 can then leverage a DC component output by the low-pass filter to interpret a voltage power-point condition for the input voltage. During operation of the power regulator module 120, the DC component of the de-modulated signal output from the de-modulator will be approximately zero when the input voltage is operating at the maximum power point voltage. Thus, the power regulator module 120 can interpret a voltage power-point condition for the input voltage as deviating from the maximum power point voltage in response to observing a non-zero DC component of the de-modulated signal output from the de-modulator.

### 4.4 Integrator: Modifying Duty Cycle

The power regulator module 120 can further include: an integrator connected to the de-modulator and the adder and configured to define a voltage-gain step for the input voltage at the power supply based on the de-modulated signal; and an adder connected to the integrator and the gain control of the power supply and configured to adjust the input voltage based on the voltage-gain step output by the integrator.

During operation, the integrator can receive the de-modulated signal output by the de-modulator and apply an integration operation to the de-modulated signal during a power cycle. The power regulator module 120 can then define a corrective voltage-gain step based on the polarity and magnitude of the DC component of the de-modulated signal: to increase the input voltage in response to the input voltage falling below the maximum power point voltage; or to decrease the input voltage in response to the input voltage rising above the maximum power point voltage. The power regulator module 120 can then apply the voltage-gain step defined by the integrator to the gain control of the power supply via the adder to adjust the input voltage toward the maximum power point voltage.

Thus, during operation, the power regulator module 120 can execute multiple power cycles to iteratively adjust the input voltage until the maximum power point voltage is achieved and the power regulator module 120 is operating at maximum power output.

### 4.4 Onboard Battery

In one implementation, the power regulator module 120 also includes: an onboard battery; and a charging circuit configured to charge the battery from power supplied by the solar panel on which the power regulator module 120 is installed (and/or from a shared bus of other power regulator modules 120 within the same solar substring).

Thus, while the solar array is operational and the power regulator module 120 is in an operating mode: the charging circuit can maintain the battery in a charged state; and the power regulator module 120 can source power from its corresponding solar panel. However, responsive to a shutdown event (i.e., failure to receive a valid token within the threshold shutdown duration), the power regulator module 120 can: deactivate the voltage and/or power output of the solar panel; enter a sleep or low-power mode; and source power from the battery to scan for, receive, and/or validate new tokens and to query the hub for confirmation to reenter the operating mode. Upon receiving a valid token and subsequently confirming reactivation with the hub: the power regulator module 120 can return to the operating mode; the charging circuit can maintain the battery in a charged state; and the power regulator module 120 can source power from its corresponding solar panel.

### 5. Hub

Generally, the hub is configured: to monitor operation of the solar array; to verify normal operation of the solar array; to broadcast tokens during periods of normal solar array operation, thereby actively triggering power regulator modules 120 to maintain power delivery to the inverter during periods of normal solar array operation; and to cease broadcast of tokens during periods of abnormal solar array operation, thereby passively triggering power regulator modules 120 to shut down during periods of abnormal solar array operation.

In particular, the hub can define a discrete device coupled to the solar array, such as adjacent the inverter. Alternatively, the hub can be integrated into a single inverter connected to the entire solar array or integrated into a string inverter coupled to an individual string within the solar array.

The hub can include a wireless communication module 128 configured to: wirelessly broadcast tokens; to wirelessly transmit commands specifying power output, voltage output, and/or other operational conditions and setpoints to power regulator modules 120 within the solar array; and/or to receive status telemetry, and/or rejoin requests from these power regulator modules 120.

### 5.1 Sensors+Controller

The hub can also include a set of integrated sensors and/or interface with a set of external sensors, such as arranged in the inverter, on a DC bus of the inverter or solar array, on string buses, or coupled to power regulator modules 120 or solar panels. For example, the hub can include or interface with: a bus-voltage sensor configured to output a bus-voltage signal representing voltage across a DC bus of the inverter; a grid-frequency sensor configured to output a grid-frequency signal representing an alternating-current frequency of a utility grid connected to an output of the inverter; a phase-detection sensor configured to output a phase-condition signal representing a stability of a phase relationship of the utility grid; a smoke sensor configured to output a smoke signal representing presence of smoke detected proximal the solar array; a temperature sensor configured to output a temperature signal representing a temperature of the inverter; a current sensor configured to output a current signal representing a current through the DC; a bus, communication port, or wireless communication module configured to receive a shutdown or enable signal from the inverter; and/or a manual-shutdown switch configured to output a manual-shutdown signal indicating manual shutdown of the solar array, such as by an operator.

The hub also includes a controller. During operation, the controller can: monitor the bus-voltage signal, the grid-frequency signal, the phase-condition signal, the smoke signal, and/or the manual-shutdown signal; generate a new token and trigger the wireless communication module 128 to broadcast this new token if each of these signals falls within a (predefined) normal operating range or state over a current or last token interval (e.g., one second, five seconds); and otherwise withhold generation and broadcast of a new token (and actively broadcast a shutdown command or shutdown token, as described below) if any one, some, or all of these signals fall(s) outside of the normal operating range or state during the current token interval or over a time window (e.g., 10 seconds) spanning the current and preceding token intervals.

For example and as shown in FIG. 1, the controller can detect abnormal operation of the solar array responsive to: an average bus-voltage signal during the current and/or preceding token intervals falling outside of the nominal operating voltage range of the inverter (e.g., less than 360 volts or greater than 480 volts DC for more than five of the last ten seconds in a 400-volt nominal system); a drift, deviation, or spread of the grid-frequency signal during the current and/or preceding token intervals exceeding a threshold band corresponding to or indicating instability of the alternating-current frequency output by the inverter (e.g., average frequency less than 57 Hz or greater than 63 Hz, or short-term frequency excursions exceeding ±1 Hz for more than five of the last ten seconds); an average or variance of the phase-condition signal during the current and/or preceding series of token intervals falling outside of a normal bound and thus indicating loss of phase synchronization with the grid (e.g., phase deviation greater than 10 electrical degrees or phase-shift rate exceeding 5 degrees per second for more than five of the last ten seconds); the smoke signal indicating presence of smoke near the solar array for more than a threshold proportion of the current and/or preceding series of token intervals (e.g., five seconds of the last ten sensed seconds at or above a smoke-density threshold corresponding to 0.1 dB/m attenuation); the temperature signal indicating that the inverter has exceeded a thermal limit for more than a threshold time limit (e.g., greater than 90° C. for more than 30 seconds); the current signal indicating a bus current exceeding a current threshold for more than a threshold time limit (e.g., more than 125% of a nominal bus current for five consecutive seconds); and/or the manual shutdown signal indicating a manual shutdown mode selected at the manual-shutdown switch.

In response to detecting such deviation(s) of the solar array from nominal operation, the hub can cease generation and broadcast of new tokens. The hub can also: transmit a rapid-shutdown command to the power regulator modules 120 via the wireless-communication module; log the condition that triggered this shutdown event; and upload log data and a fault flag to a remote computer system or operator portal. Additionally or alternatively, response to detecting deviation of the solar array from nominal operation, the hub can wirelessly transmit an explicit shutdown command or a shutdown token to all or a subset of power-regulator modules. In response to receiving and authenticating this explicit shutdown command or shutdown token, a power-regulator module can immediately enter the shutdown mode, such as regardless of timing or receipt of a valid hub-generated token.

### 6. Solar Array

Generally, the solar array can include a set of solar panels, each installed on a structure (e.g., one or more roof surfaces of a residential or commercial building) and including or connected to a power regulator module 120. These power regulator modules 120 can be grouped into solar strings, wherein each power regulator module 120 in a group is connected (i.e., wired) in series, and wherein these solar strings are connected (i.e., wired) in parallel to a common solar inverter. The hub can thus execute methods and techniques described herein to coordinate power regulator set points across power regulator modules 120 in each solar string.

In this implementation, the hub can define an external device configured to execute Blocks of the method S100 and arranged on or near the solar inverter. Alternatively, the hub can be integrated into the solar inverter or manifest in a remote computer system (e.g., a remote server, a computer network).

Alternatively, each solar string can be connected (i.e., wired) to one string inverter (or “micro-inverter”), and each string inverter can be connected (i.e., wired) to the structure or shore power. In this implementation, the hub can define an external device configured to execute Blocks of the method S100 and arranged on or near the solar array. Alternatively, the hub represented virtually across the set of string inverters or virtually in a remote computer system (e.g., a remote server, a computer network).

### 7. Solar String+Solar Array Membership

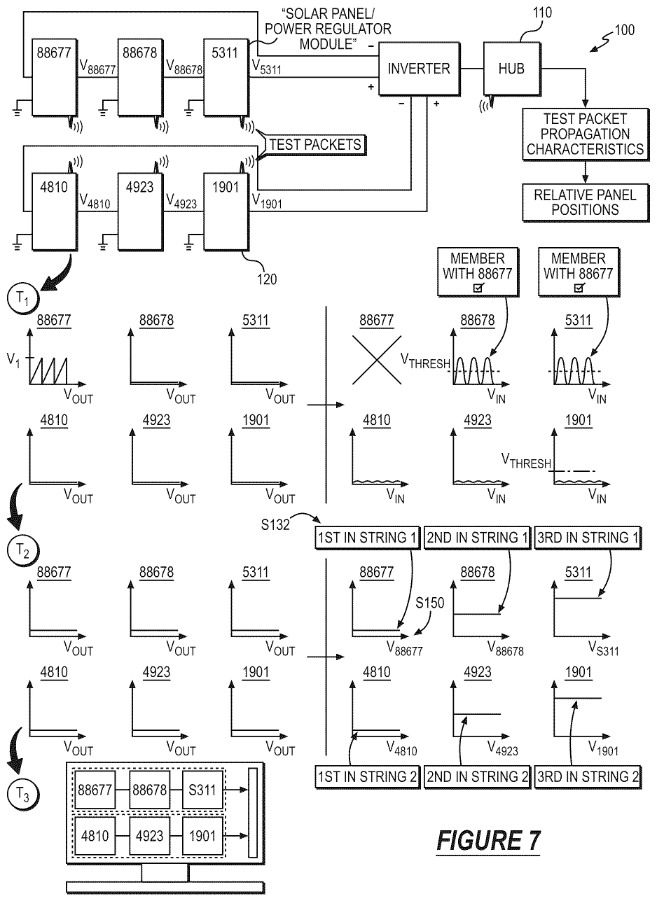

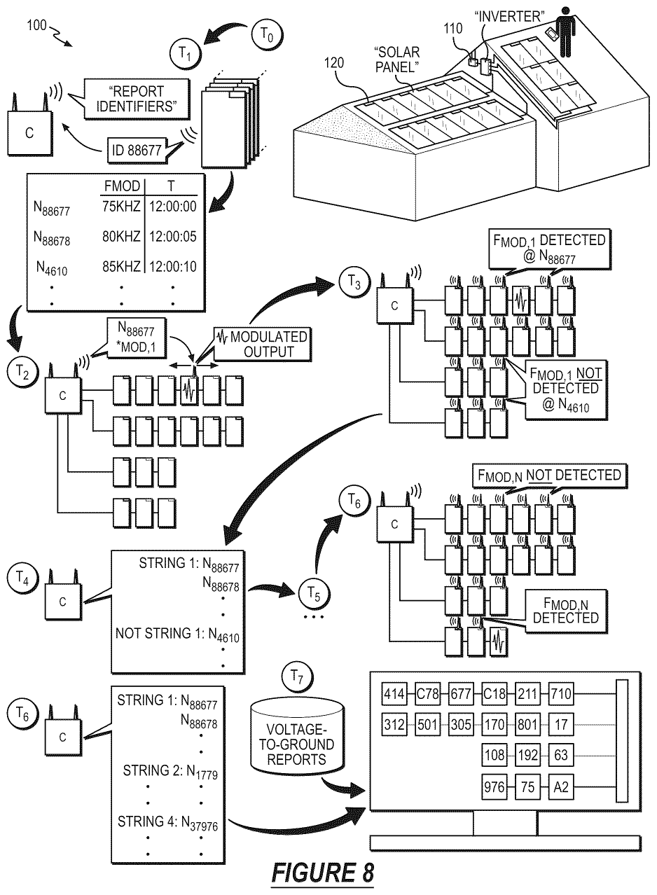

Generally, a set of solar panels—each connected to or incorporating an integrated power regulator module 120—can be installed on a structure (e.g., a roof) and coupled (e.g., in series) to form a set of solar strings connected (e.g., in parallel) to an inverter to form a solar array. The hub can be coupled to or integrated into the inverter and can cooperate with the power regulator modules 120 to automatically detect and identify power regulator modules 120 (or solar panels) in the solar array and/or specific solar string memberships of each power regulator module 120 (or solar panel) in the solar array, as shown in FIGS. 7 and 8.

In particular, the hub can: wirelessly broadcast interrogation signals; receive wireless responses—including power regulator module 120 or solar panel identifiers—from nearby power regulator modules 120; compile these responses into a list of power regulator modules 120 (and/or solar panels) in the solar array; and estimate positions and/or solar string memberships of the power regulator modules 120 based on wireless signal characteristics of these responses. Additionally or alternatively, a remote computer system or computing device can estimate positions and/or solar string memberships of the power regulator modules 120 based on wireless signal characteristics of these responses. Furthermore, the hub can coordinate modulated voltage outputs by individual power regulator modules 120 and interpret solar string memberships of these power regulator modules 120 based on detection of these modulated voltages by other power regulator modules 120 in the solar array.

For example, each power regulator module 120 can interpret coupling strength to neighboring modules by detecting small-amplitude voltage ripples induced on the DC bus when another module modulates its output duty cycle at a distinct modulation frequency (e.g., 400 Hz-2 kHz, outside the control bandwidth of the inverter). The module can compute correlation between its measured output-voltage timeseries and known modulation signatures broadcast by the hub to identify direct electrical neighbors.

### 7.1 Solar Panel List

In one implementation, following installation of the set of solar panels and power regulator modules 120 on the structure, connection of the solar panels and power regulator modules 120 to form solar strings, and connection of the solar strings to the solar inverter by an installer, the hub can initialize a string identification cycle. During the string identification cycle, the hub can wirelessly broadcast a query to report power regulator module identifiers; receive a set of responses from a population of power regulator modules 120, proximal the hub, responsive to this query; and assemble a list of unique power regulator module identifiers—that may be incorporated in the solar array—based on these responses. For example, upon receipt of this query, each power regulator module 120 can return a unique identifier—stored in local memory 129—to the hub. The hub can also: estimate distances between these power regulator modules 120 and the hub based on signal strengths of responses to the query received from these power regulator modules 120; identifying a set of power regulator modules 120 within a threshold distance of the hub and thus most likely within the solar array; and generate or revise the list of unique power regulator module identifiers to include only identifiers of power regulator modules 120 that fall within the threshold distance of the hub or otherwise are associated with response signal strengths that indicate proximity to the hub.

Therefore, the hub can automatically identify power regulator modules 120 (likely) in the solar array.

Additionally or alternatively, the hub can access a list of power regulator module identifiers assembled by the installer, such as by manually scanning barcodes on power regulator modules 120 or by manually entering serial numbers of these power regulator modules 120 during installation.

The hub can then generate a schedule for triggering power regulator modules 120 in the solar array to output test signals during the string identification cycle, such as all power regulator modules 120 sequentially, a subset of power regulator modules 120 sequentially, or subsets of power regulator modules 120 in parallel, as described below.

### 7.2 String Identification

Generally and as shown in FIG. 8, the hub can: trigger a first power regulator module 120 in the solar array to output test signals (e.g., low peak-to-peak-voltage “ripples”) at particular modulation frequencies while (all) other power regulator modules 120 in the solar array output a fixed direct-current voltage in a test mode; identify a group of interconnected power regulators modules—including the first power regulator module 120—that forms one solar string in the solar array based on detection of this test signal at their output terminals; and repeat this process for other power regulator modules 120 in the solar array in order to identify every solar string in the solar array and the specific power regulator modules 120 wired in series within each solar string.

In particular, upon identifying each power regulator module 120 in the solar array, the hub can wirelessly broadcast a command to enter a test mode to all power regulator modules 120 in the solar array. In the test mode, each power regulator module 120 can operate at a fixed duty cycle (e.g., 1%) or otherwise output a fixed direct-current voltage (e.g., a constant 1.0 Volt DC). More specifically, the hub can trigger each power regulator module 120 to output a fixed voltage such that the total voltage output by each solar string in the inverter reaches a minimum input voltage of the inverter, enabling these power regulator modules 120 to detect modulations across their output terminals when another power regulator module 120 in the solar array is triggered by the hub to output a modulated signal. For example, the hub can trigger these power regulator modules 120 to output the same (or “common,” target) direct-current voltage (e.g., 1.0 Volt DC). Alternatively, the hub can trigger each power regulator module 120: to record its current output voltage (e.g., its current maximum power point voltage); and to maintain (or “hold”) this current output voltage throughout the duration of the first test period (and thus pause all maximum power point tracking techniques).

In this implementation, the hub can then: select a first power regulator module 120 in the solar array; assign a first test period (e.g., a first test start time and a test duration, such as five seconds) to the first power regulator module 120; retrieve or otherwise assign a nominal modulation frequency (e.g., 50 Hz) to the first power regulator module 120; select or otherwise assign a modulation signal shape (or a sinusoidal, square, sawtooth signal profile) to the first power regulator module 120; set or otherwise assign a test output center voltage to the first power regulator module 120, such as the same fixed direct-current voltage output by all other power regulator modules 120 during this test period, a current maximum power point tracking voltage of the first power regulator module 120, or another target direct-current voltage (e.g., 1.0 Volt DC); and set or otherwise assign a test output alternating voltage to the first power regulator module 120, such as a peak-to-peak voltage equal to 10% of the test output center voltage assigned to the first power regulator module 120 during this test period. The hub then: wirelessly broadcasts a command to output an alternating signal at the modulation frequency, centered around the test output center voltage (or around an output voltage corresponding to the nominal duty cycle), characterized by a peak-to-peak voltage according to the test output alternating voltage, and approximating the modulation signal shape over the first test period to the first power regulator module 120; and wirelessly broadcasts commands to other power regulator modules 120 in the solar array to record voltage timeseries across their output terminals during this first test period.

The first power regulator module 120 then: sources power from its corresponding solar panel; and modulates its duty cycle at the modulation frequency to reproduce an alternating test signal during this first test period. Concurrently, each other power regulator module 120 records a voltage and/or current timeseries across its output terminals.

In one implementation, these power regulator modules 120 return their voltage and/or current timeseries to the hub (e.g., via wireless communication protocol), and the hub implements filtering, debouncing, Fourier analysis, and/or other signal processing techniques to search each voltage timeseries for a signal component: at or near the modulation frequency; and/or exhibiting an amplitude greater than a threshold amplitude that indicates direct wired connectivity between power regulator modules 120. The hub then: assembles a list of power regulator modules 120 (e.g., power regulator module identifiers) that returned voltage timeseries that included such signal components; associates these power regulator modules 120 with the first power regulator module 120; and assigns a first solar string identifier of a first solar string in the solar array to these power regulator modules 120 and the first power regulator module 120. The hub can also record absence of a power regulator module 120 from the first solar string responsive to absence of this signal component in a voltage timeseries received from this power regulator module 120.

Alternatively, the hub can transmit the modulation frequency to other power regulator modules 120 in the solar array. Each power regulator module 120 can thus: capture a voltage timeseries across its output terminals during the first test period; locally implement filtering, debouncing, Fourier analysis, and/or other signal processing techniques to search this voltage timeseries for a signal component at or near the modulation frequency and/or exhibiting an amplitude greater than the threshold amplitude; and return confirmation of presence or absence of this signal component to the hub. The hub can then: assemble a list of power regulator modules 120 (e.g., power regulator module identifiers) that returned confirmation of this signal component; associate these power regulator modules 120 with the first power regulator module 120; and assign a first solar string identifier of a first solar string in the solar array to these power regulator modules 120 and the first power regulator module 120. The hub can also record absence of a power regulator module 120 from the first solar string responsive to confirmation of absence of this signal component from this power regulator module 120.

The computer system can then repeat this process for each other power regulator module 120 in the solar array to both: detect new groups of interconnected power regulator modules 120 and assign new solar string identifiers of new solar strings to these new groups of power regulator modules 120; and to verify or reinforce groups of interconnected power regulators detected during prior test periods during this string identification cycle. For example, a particular power regulator module 120 should only exist within one solar string and, therefore, should detect signal components characterized by the modulation frequency only during test periods in which other power regulator modules 120 in the same solar string output modulation signals. Thus, if the hub detects the presence of a particular power regulator module 120 in two groups, the computer system can: increase the threshold amplitude and restart the string identification cycle; and/or prompt the installer to manually confirm that the solar string contains the particular power regulator module 120.

Alternatively, the hub can: maintain a list of power regulator modules 120 not yet grouped into a solar string; and sequentially execute the foregoing method (i.e., triggering output of a modulation signal and detection of corresponding signal components at output terminals of other power regulator modules 120 in the solar array) only at power regulator modules 120 remaining on this list in order to reduce total count of test periods and total duration of the string identification cycle.

Therefore, the hub can dynamically identify and organize power regulator modules 120 into coherent groups corresponding to their physical and electrical relationships within the solar array.

### 7.3 External Solar Panel Rejection

In another implementation, the hub can remove a particular power regulator module 120 from the solar panel list (e.g., a solar panel list generated automatically based on responses to a query broadcast wirelessly by the hub) in response to failure of all power regulator modules 120 in the solar array to detect a signal component—at their output terminals—matched to characteristics of the modulation signal output by the particular power regulator module 120. For example, if the solar array is installed on a roof of a single-family dwelling near a second single-family dwelling with a second solar array, a power regulator module 120 in the second solar array may report an identifier to the hub responsive to a query broadcast by the hub, and the hub can include this identifier on the solar panel list. However, because the second power regulator module 120 is not connected to the solar array, no modulation signal output by the second power regulator module 120 will be detected by power regulator modules 120 in the solar array. The hub can thus remove the second solar array from the solar panel list if no power regulator module 120 in the solar array reports detection of signal components matched to the characteristics of the modulation assigned to the second power regulator module 120 during the test period assigned to the second power regulator module 120.

### 7.4 Panel Sequence Per Solar String

In one variation shown in FIG. 7, the hub detects an order of power regulator modules 120 connected in series within a solar string.

### 7.4.1 Module Sequencing Based on Modulation Signal Strength

In this variation, once the hub identifies a subset of power regulator modules 120 within one solar string, the hub further interprets an order of these power regulator modules 120 within the solar string based on amplitudes of modulation signal components output and detected by these power regulator modules 120 during the string identification period.

In one implementation, the hub can: trigger a first power regulator module 120 to output a modulation signal during a first test period; detect this modulation signal at a first amplitude greater than a threshold amplitude at a second power regulator module 120; detect this modulation signal at a second amplitude greater than the threshold amplitude but less than the first amplitude at a third power regulator module 120; and detect this modulation signal at a third amplitude less than the threshold amplitude and the second amplitude at a fourth power regulator module 120. Accordingly, the hub can: identify membership of the first, second, and third power regulator module s120 in a first solar string; identify the first power regulator module 120 as furthest from the inverter in the first solar string; identify the third power regulator module 120 as nearest the inverter in the first solar string; identify the second power regulator module 120 as between the first and third power regulator modules 120 in the first solar string; and identify the fourth power regulator module 120 as outside of the first solar string.

The hub can also: trigger the second power regulator module 120 to output a modulation signal during a second test period; detect this modulation signal at a first amplitude greater than the threshold amplitude at the first power regulator module 120; detect this modulation signal at a second amplitude greater than the threshold amplitude and greater than or less than the first amplitude at the third power regulator module 120; and detect this modulation signal at a third amplitude less than the threshold amplitude at a fourth power regulator module 120. Accordingly, the hub can reinforce the solar string membership and string order previously interpreted based on the modulation signal presence and amplitude results.

In another example, the hub can: detect a first inbound signal, characterized by a first modulation frequency, at a first signal amplitude at a second power regulator module 120 during a first test period; detect a second inbound signal, characterized by the first modulation frequency, at a second signal amplitude at a third power regulator module 120 during the first test period; and detect membership of the first, second, and third power regulator modules 120 in a first solar string in response to the first and second signal amplitudes exceeding the threshold signal amplitude. Furthermore, in response to the first signal amplitude exceeding the second signal amplitude, the hub can: predict a first distance between the first power regulator module 120 and the second power regulator module 120 in the first solar string; and predict a second distance—greater than the first distance—between the first power regulator module 120 and the third power regulator module 120 in the first solar string. The hub can repeat this process for all power regulator modules 120 in the solar array and derive an order of power regulator modules 120 in each solar string that resolves these amplitude-based relative distances or proximities between power regulator modules 120.

### 7.4.2 Module Sequencing Based on Voltage Gradient

Additionally or alternatively, the hub can interpret an order of power regulator modules 120 within a solar string based on voltages between output terminals of these power regulator modules 120 and ground, as shown in FIG. 7.

In particular, each power regulator module 120 (or solar panel more generally) can be connected (i.e., wired) to earth ground and can include a position amplifier configured to detect a voltage difference between a negative terminal on the power regulator module 120 and earth ground. During the string identification period, the hub can trigger each power regulator module 120 in a string to: output a small voltage (e.g., one volt, one-percent duty); detect its output voltage relative to earth ground; and report this voltage-to-ground value to the hub. Because these power regulator modules 120 are connected in series within the solar string: a first power regulator module 120 in the solar string further from the inverter may report a lowest voltage-to-ground value; a second power regulator module 120 in the solar string downstream of the first power regulator module 120 may report a greater voltage-to-ground value (i.e., a sum of the voltage outputs of the first and second power regulator modules 120); and a third power regulator module 120 in the solar string may report an even greater voltage-to-ground value (i.e., a sum of the voltage outputs of the first, second, and third power regulator modules 120); etc.

Therefore, the hub can interpret an order of power regulator modules 120 within the solar string based directly on voltage-to-ground values reported by these power regulator modules 120. In particular, the hub can derive a sequential arrangement of power regulator modules 120 within a solar string based on ascending voltage-to-ground values detected by these power regulator modules 120 when operating together at greater than the quiescent voltage.

### 7.5 Wireless Mapping

In one variation, the hub: triggers solar panels, in the set of solar panels, to wirelessly broadcast test packets; accesses a set of propagation characteristics (e.g., round-trip time, phase difference, received signal strength) of test packets received by the set of solar panels; and calculates relative positions of the set of power regulator modules 120 based on the set of propagation characteristics. For example, the hub can: load assumptions that groups of solar panels in the solar array are installed on a common plane (e.g., a flat or pitched roof) and that each power regulator module 120 is attached on (the back of) its corresponding solar panel; retrieve dimensions of the solar panels; implement received signal strength indicator, round-trip time, and/or multi-carrier phase difference techniques to estimate pairwise distances between pairs of power regulator modules 120; implement trilateration and/or multidimensional scaling techniques to transform these pairwise distances into relative three-dimensional position estimates of the power regulator modules 120; implement plane-fitting techniques to calculate one or more best fit planes proximal position estimates of groups of power regulator modules 120; collapse (e.g., shift along a vertical axis) each power regulator module 120 position estimate onto its corresponding plane in order to reflect installation of solar panels onto flat or pitched roof structures; and laterally and longitudinally adjust each power regulator module 120 position estimate within its plane to enforce lateral and longitudinal pitch offsets between power regulator modules 120 that reflect at least minimum dimensions of the solar panels.

The hub can thus transform propagation characteristics of wireless test packets transmitted between solar panels into a three-dimensional map (or “virtual map”) of relative positions of each power regulator module 120 (or a wireless communication module 128 or antenna specifically within each power regulator module 120).

### 7.6 Virtual Map

The hub (or a remote computer system) then: aggregates propagation characteristics of these wireless test signals; and fuses these propagation characteristics with string memberships and/or string sequences derived from wired test signals collected during the string identification period to automatically generate a virtual map of the solar array, such as including relative positions and identifiers of each power regulator module 120 and solar panel in the solar array.

More specifically, the hub (and/or the remote computer system) can compile propagation characteristics of both wireless and wired signals broadcast between power regulator modules 120, voltage-to-ground values detected by power regulator modules 120, and known geometries (e.g., lengths, widths) of solar panels to generate a virtual map, geometric model, or other graphical representation of relative positions of each solar panel, membership and order of each solar panel in a string, and identifiers of corresponding power regulator modules 120.

The hub can also annotate the virtual map with representations of electrical interconnections between power regulator modules 120 and/or solar panels. For example, the hub can: connect representations of power regulator modules 120 within one solar string with icons (e.g., lines) representing serial wired interconnections between these power regulator modules 120 based on the derived order of power regulator modules 120 in this string; project a bounding box around representations of power regulator modules 120 in this string in the virtual map; and annotate this bounding box with a solar string identifier in the virtual map.

The hub can also distribute string-relationship data to the power regulator modules 120, such as identifiers (e.g., wireless IDs) of each power regulator module 120 contained in each solar string in the solar array. As described below, each module can thus: communicate planned (i.e., upcoming, imminent) shutdown and rejoin actions to neighboring power regulator modules 120 within the same solar string to enable these other power regulator modules 120 to preemptively adjust their outputs, such as to avoid over- or under-voltage or over- or under-power events within the solar string; and/or share maximum power points with neighboring power regulator modules 120 within the same solar string to enable these power regulator modules 120 to more rapidly find their (unique) maximum power points.

### 8. Site Keys+Tokens

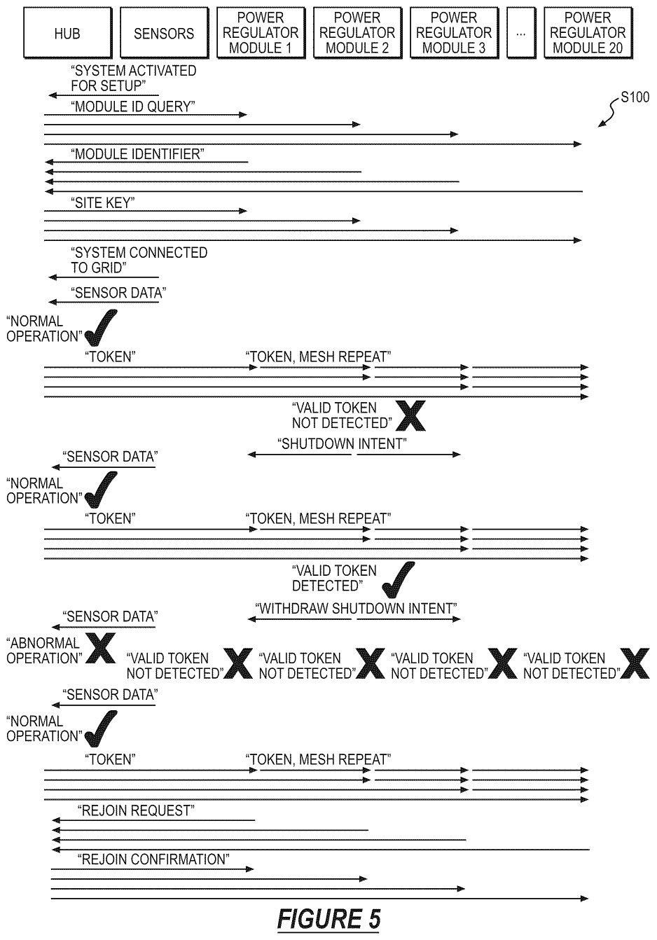

Generally, the hub can generate tokens, such as time-based rolling codes. A power regulator module 120 intercepts and attempts to authenticate these tokens based on a local copy of a site key in order to confirm normal operation of the solar array and persistence of its current operating mode, as shown in FIGS. 1 and 5.

In one implementation, the hub implements a symmetric encryption or keyed-hash method seeded with a site key to generate a token on a regular time interval (or “heartbeat frequency,” “heartbeat interval”). For example, the hub can: compute a hash-based message authentication code (or “HMAC”) of a current time value or rolling sequence counter concatenated with an identifier of the hub, such as based on SHA-256 or SHA-3 protocol; generate a new token by truncating the resulting digest to a fixed length (e.g., 128 bits); and broadcast this new token via the wireless communication module 128, such as at a rate of 1 Hz. In another example, the hub can encrypt a counter value based on a block cipher, such as AES-128 in counter mode, to generate a new token. In these examples, each power regulator module 120 can: store a corresponding site key in local memory 129; locally execute corresponding computations based on its stored site key to generate an internal verification token for the current time interval; and authenticate a new token received by the wireless communication module 128 during the current time if the new token matches the internal verification token within a defined timing tolerance.

In another implementation, the hub: implements an authenticated-encryption scheme (e.g., AES-GCM, AES-CCM, or ChaCha20-Poly1305) to encrypt a structured payload, such as a packet containing a timestamp, a hub identifier, a sequence counter, and/or a checksum; and generates a new token based on this encrypted structured payload; and broadcast this new token via the wireless communication module 128, such as at a rate of 1 Hz. Each power regulator module 120 can then: store a corresponding site key in local memory 129; decrypt a new token—received by the wireless communication module 128—based on its local copy of the site key; and authenticate the token if decryption of the token via the site key yields a coherent payload with fields that pass range, sequence-order, and/or checksum checks.

Additionally or alternatively, the hub can implement monotonic sequence-number validation when generating a token in order to prevent rebroadcast (or “replay”) of a past token from maintaining a power regulator module in the operating mode when then hub is not actively broadcasting valid tokens.

However, the hub and the power regulator modules 120 can implement any other encryption, token generation, and/or token validation schema to distribute and validate solar array heartbeats, respectively.

### 8.1 Site Key Distribution

Generally, the hub can be preloaded with a unique site key, such as pre-encoded in firmware prior to installation of the hub into the solar array. Alternatively, the hub can generate or configure a new site key, such as during the setup period or otherwise after install and activation within the solar array. The hub can then distribute this site key to the power regulator modules 120 in the solar array during the setup period.

In one implementation shown in FIGS. 1 and 5, the hub is configured to broadcast an identification query during a setup period preceding an operating period of the solar array. Accordingly, a first power regulator module 120 in the solar array can return (e.g., wirelessly broadcast) a first identifier of the first power regulator module 120 to the hub in response to receipt of the identification query from the hub. In response to receipt of the first identifier from the first power regulator module 120 responsive to the identification query during the setup period, the hub can: populate a solar array manifest with the first identifier of the first power regulator module 120; and return a first site key—associated with the solar array—to the first power regulator module 120. The first power regulator module 120 can then store this first site key in local memory 129. The hub can similarly distribute the same (or other) site key to other power regulator modules 120 in the solar array during the setup period.

In one configuration, the solar array includes a single hub, a single inverter, multiple solar strings, and one or more power regulator modules 120 per substring. In this configuration, the set of power regulator modules 120 can implement a common (i.e., single, identical) site key. During operation, the hub can generate rolling-code tokens based on a current time value and the common site key, and each power regulator module 120 can maintain a local clock synchronized with the hub within a tolerance sufficient for rolling-code verification. Each power regulator module 120 can authenticate tokens broadcast by the hub based on its stored copy of the common site key and the synchronized time reference.

In another configuration, the solar array includes a single hub, a single inverter, multiple solar strings, and one or more power regulator modules 120 per substring. In this configuration, each power regulator module 120 maintains a unique site key, and the hub maintains a site key table indexed to identifiers of power regulator modules 120 in the solar array. The hub can: thus generate a unique token for each power regulator module 120 by hashing a current time or counter value with site keys specific to each power regulator module 120; and broadcast these module-specific tokens, individually or sequentially, during each heartbeat interval. Each power regulator module 120 may thus receive multiple tokens but successfully authenticate only its corresponding token based on its unique site key. Thus, in this implementation, the hub can also selectively deactivate individual power regulator modules 120 (or trigger specific power regulator modules 120 to shut down) by withholding broadcast of a token generated according to the site key unique to this power regulator module 120, such as rather than or in addition to transmitting a specific rapid-shutdown command to this power regulator module 120.

In another configuration, the solar array includes a single inverter, multiple solar strings, a single hub per solar string, and one or more power regulator modules 120 per substring. In this configuration, each hub can: generate and distribute a single site key to all power regulator modules 120 within its corresponding solar string; and generate and broadcast tokens based on its assigned site key. Each power regulator module 120 may thus receive tokens from multiple hubs in the solar array but can authenticate tokens specifically generated and broadcast by the hub in its corresponding solar string. Thus, in this implementation, a hub can selectively deactivate all power regulator modules 120 in its solar string by withholding broadcast of a token generated according to the site key unique to this solar string, such as rather than or in addition to transmitting a specific shutdown command to these power regulator modules 120.

Therefore, the hub can generate, broadcast, and rotate cryptographically-secure tokens based on common or unique site keys distributed to power regulator modules 120 in the solar array, and each power regulator module 120 can authenticate these tokens locally to individually verify normal operation of the solar array and their own operating mode statuses.

### 8.2 Manual Site Key Distribution

In one variation, a remote computer system or mobile device generates or configures a new site key for the site. Once load onto or generated by the mobile device (e.g. a smartphone or tablet)—such as during the setup period, after install, or after activation—an operator may manually load this site key from the mobile device to each power regulator module, such as over wireless communications between the mobile device and the power regulator modules. Alternatively, the operator may manually load this site key from the mobile device onto a thumb drive or other hard drive and manually insert the thumb drive or other hard drive and into each power regulator module in order to load the site key onto these power regulator modules.

### 9. Hub Operation

Following the setup period and as shown in FIG. 1, the hub can: implement methods and techniques described above to sample and monitor the solar array via integrated or external sensors; listen for enable or shutdown signals from the inverter; and detect normal or abnormal operation of the solar array based on signals output by these sensors and signals from the inverter. In response to detecting normal operation of the solar array during this operating period based on these sensor data, the hub can generate and broadcast a series of tokens at a target time interval (e.g., 1 Hz, 0.5 Hz). Conversely, in response to detecting deviation of the solar array from nominal operation based on these sensor data, the hub can cease broadcast of tokens.

In one implementation, the hub: defines or implements a token interval (e.g., one second, two seconds); samples the sensors throughout the token interval, such as at a rate of 10 or 100 Hz; and interprets normal or abnormal operational status of the solar array once per token interval based on these sensor data. If the hub detects abnormal operational status of the solar array during the current token interval, the hub can withhold transmission of a new token for this token interval. Accordingly, a power regulator module 120 in the solar array will fail to receive a valid token for this token interval. However, the power regulator module 120 can detect and confirm a shutdown event only after a threshold count of (e.g., three) consecutive token intervals, thereby increasing robustness of the system 100 to token collisions and wireless noise while achieving rapid shutdown (e.g., within 30 seconds of a rapid-shutdown event, or the product of the threshold count of consecutive tokens and the token interval).

Additionally or alternatively, the hub can withhold transmission of a new token for the current token interval: if the hub detects abnormal operational status of the solar array during the current token interval and a threshold count of (e.g., three) consecutive preceding token intervals; or if the hub detects abnormal operational status of the solar array during the current token interval and at least a threshold proportion of the preceding token intervals (e.g., three of the last five token intervals). For example, the hub can detect abnormal operation of the solar array responsive to: sustained excessive alternating-current components in the inverter-bus voltage for at least 30 seconds (e.g., three consecutive token intervals); sustained over-voltage supplied to the inverter for at least five seconds (e.g., 50 percent of one token interval); sustained under-voltage supplied to the inverter for at least ten seconds (e.g., one complete token interval); or instantaneous activation of the manual-shutdown switch. Accordingly, a power regulator module 120 in the solar array can: immediately detect a shutdown event responsive to failure to receive a valid token for this token interval; or detect a shutdown event responsive to failure to receive a valid token for this token interval and a small count of (e.g., one) prior token intervals, thereby shifting more shutdown-timing control to the hub and decreasing rapid-shutdown response time (e.g., to as little as 10 seconds after detection of abnormal operation by the hub).

As described below, the hub can later resume generation and broadcast of tokens, such as responsive to manual reset of the solar array (or the hub specifically) or cycling of the manual-shutdown switch, thereby triggering power regulator modules 120 in the solar array to transition from a shutdown mode to the operating mode.

Furthermore, the hub may necessarily cease broadcast of tokens if the hub itself fails or otherwise becomes non-operational. Accordingly, when the hub is non-operational and therefore no longer monitoring the solar array, each power regulator module 120 in the solar array can: detect a shutdown event due to absence of receipt of valid tokens; and automatically deactivate (i.e., transition to the shutdown mode) accordingly.

### 9.1 Example: Bus Voltage

In one example, the hub can implement a nominal operating-voltage range of the inverter, such as 380 to 480 volts DC for a 400-volt nominal system. In this example, during a first token interval, the hub can: access a bus voltage detected by a voltage sensor coupled to the inverter; detect nominal operation of the solar array in response to the bus voltage falling within the nominal operating-voltage range; and generate and broadcast a new token accordingly. In this example, during a second token interval, the hub can: again access the bus voltage detected by the voltage sensor; detect deviation of the solar array from nominal operation in response to the bus voltage falling outside of the nominal operating-voltage range (e.g., less than 360 volts or greater than 500 volts DC); and thus withhold broadcast of a new token accordingly.

### 9.2 Example: Voltage Instability

In another example, the hub can implement a nominal ripple-band representing electrical stability of the solar array (or power supplied by all power regulator modules 120 in the solar array) and defining a frequency range of approximately 100 to 500 Hz and an amplitude range less than 2 percent of the DC-bus voltage. In this example, during a first token interval, the hub can: access a first time-series of bus-voltage samples detected by a voltage sensor coupled to the inverter; extract a first alternating-current component from the first time-series of bus voltages; and detect nominal operation of the solar array in response to the first alternating-current component exhibiting a frequency within the nominal ripple-band corresponding to electrical stability of the solar array; and generate and broadcast a new token accordingly.

In this example, during a second token interval, the hub can: again access a second time-series of bus-voltage samples detected by the voltage sensor; extract a second alternating-current component from the second time-series of bus voltages; detect deviation of the solar array from nominal operation in response to the second alternating-current component exhibiting a frequency outside of the nominal ripple-band or an amplitude greater than the amplitude limit; and thus withhold broadcast of a new token accordingly.

### 9.3 Example: Smoke

In another example, during a first token interval, the hub can: access a smoke signal from a smoke detector proximal to the solar array; detect nominal operation of the solar array in response to the smoke signal indicating absence of smoke proximal to the smoke detector; and generate and broadcast a new token accordingly. In this example, during a second token interval, the hub can: again access the smoke signal from the smoke detector; detect deviation of the solar array from nominal operation in response to the smoke signal indicating presence of smoke proximal the smoke detector; and thus withhold broadcast of a new token accordingly.

### 10. Power Regulator Module Operation

As described above, a power regulator module 120 is coupled to a solar panel in the solar array and includes: an isolation switch 124 operable in a closed position to output power from the solar panel to an inverter and an open position to cease output of power from the solar panel to the inverter; a wireless communication module 128; and a local memory 129 configured to store a site key.

As described above, the power regulator module 120 is configured to, during a first token interval: access a first token broadcast by a hub and received by its wireless communication module 128; authenticate the first token based on an instance of site key stored in local memory 129; and maintain the switch in the closed position in order to output power from the first solar panel to the inverter in response to authenticating the first token.

The power regulator module 120 is also configured to, during a second token interval: trigger the switch to transition to the open position in order to cease output of power from the solar panel to the inverter in response to absence of receipt of a second token by the wireless communication module 128 and/or in response to failure to authenticate any token received by the wireless communication module 128 during this token interval.

Thus, once in the shutdown mode, the power regulator module 120 can: isolate the solar panel from the inverter and/or other power regulator modules 120 in the solar array; prevent flow of current from the solar panel to the inverter or other power regulator modules 120; and continue to monitor for inbound tokens.

Additionally or alternatively, each power-regulator module can monitor for an external shutdown or enable signal output by the inverter, such as broadcast wirelessly by the hub. In response to receipt of such an external shutdown signal from the inverter, a power-regulator module can automatically and immediately enter the shutdown mode, such as regardless of timing or receipt of valid hub-generated tokens before, during, or after receipt of the external shutdown signal from the inverter. Similarly, each power-regulator module can monitor for an external shutdown or enable signal output by the hub. In response to receipt of such an external shutdown signal from the hub, a power-regulator module can automatically and immediately enter the shutdown mode, such as regardless of timing or receipt of valid hub-generated tokens before or after receipt of this external shutdown signal from the hub.

### 10.1 Failed Token Count

In one implementation shown in FIG. 6, the power regulator module 120 enters the shutdown mode after failing to receive a valid token over a threshold count of consecutive token intervals.

In particular, during a first token interval, the power regulator module 120 can: access a first token broadcast by a hub and received by its wireless communication module 128; authenticate the first token based on an instance of the site key stored in local memory 129; and maintain the switch in the closed position in order to output power from the first solar panel to the inverter in response to authenticating the first token.

In response to absence of receipt of a second token by the wireless communication module 128 during a second, subsequent token interval, the power regulator module 120 can: index a failed token counter; and maintain the switch in the closed position in order to maintain output of power from the solar panel to the inverter. (The power regulator module 120 can also broadcast a notification to other power regulator modules 120 in the solar array (e.g., specifically power regulator modules 120 in the same solar array) that the power regulator module 120 is preparing for a possible shutdown event, as described below.)

In response to receipt of a third token by the wireless communication module 128 during a third, subsequent token interval, the power regulator module 120 can: clear the failed token counter; and maintain the switch in the closed position in order to maintain output of power from the solar panel to the inverter. (The power regulator module 120 can also broadcast a notification to other power regulator modules 120 in the solar array that the power regulator module 120 is no longer preparing for a possible shutdown event, as described below.)

Conversely, in response to receipt of a third token by the wireless communication module 128 during this third, subsequent token interval, the power regulator module 120 can index the failed token counter. If the failed token counter then exceeds a threshold count—and thus if the power regulator module 120 has failed to receive a valid token within the threshold count of consecutive token intervals—the power regulator module 120 can trigger the switch to transition to the open position in order to cease output of power from the solar panel to the inverter. (The power regulator module 120 can also broadcast a notification to other power regulator modules 120 in the solar array (e.g., specifically power regulator modules 120 in the same solar array) that the power regulator module 120 has entered the shutdown mode.)

### 10.2 Shutdown Timer

In another implementation, the power regulator module 120 can enter the shutdown mode over after failing to receive a valid token within a threshold time duration, such as greater than the token interval (e.g., equivalent to a duration of three or ten token intervals).

In this implementation, during a first token interval, the power regulator module 120 can: access a first token broadcast by a hub and received by its wireless communication module 128; authenticate the first token based on an instance of site key stored in local memory 129; and maintain the switch in the closed position in order to output power from the first solar panel to the inverter in response to authenticating the first token.

In response to absence of receipt of a second token by the wireless communication module 128 during a second, subsequent token interval, the power regulator module 120 can activate a shutdown timer for the threshold time duration. (The power regulator module 120 can also broadcast a notification to other power regulator modules 120 in the solar array (e.g., specifically power regulator modules 120 in the same solar array) that the power regulator module 120 is preparing for a possible shutdown event, as described below.)

In response to receipt of a third token by the wireless communication module 128 prior to expiration of the shutdown timer, the power regulator module 120 can: clear the shutdown timer; and maintain the switch in the closed position in order to maintain output of power from the solar panel to the inverter. (The power regulator module 120 can also broadcast a notification to other power regulator modules 120 in the solar array that the power regulator module 120 is no longer preparing for a possible shutdown event, as described below.)

Conversely, in response to expiration of the shutdown timer prior to receipt of a valid token by the wireless communication module 128, the power regulator module 120 can trigger the switch to transition to the open position in order to cease output of power from the solar panel to the inverter. (The power regulator module 120 can also broadcast a notification to other power regulator modules 120 in the solar array (e.g., specifically power regulator modules 120 in the same solar array) that the power regulator module 120 has entered the shutdown mode.)

### 10.3 Redundant Switches

As described above and shown in FIG. 4, the power regulator module 120 can include: a power stage; an input isolation switch 122; and an output isolation switch 124. The input isolation switch 122 can be operable in: a closed position to couple an output of a solar panel to the power stage of the power regulator module 120; and an open position to decouple the output of the solar panel from the power stage of the power regulator module 120. The output isolation switch 124 can be similarly operable in: a closed position to couple the power stage of the power regulator module 120 to the inverter; and an open position to decouple the power stage of the power regulator module 120 from the inverter.

For example, and as described above, the power regulator module 120, the power stage specifically can include: a power supply; a modulation signal generator; a detector; a demodulator; and an integrator. The power supply can be configured to: receive an input voltage generated by the solar panel via the switch; and generate an output voltage. The modulation signal generator can be: coupled to the power supply; and configured to modulate a control input of the power supply to vary a voltage gain from the input voltage to the output voltage. The detector can be: coupled to the power supply and the modulation signal generator; and configured to characterize a power signal output by the power supply responsive to modulation of the control input of the power supply by the modulation signal generator. The demodulator can be: coupled to the detector; and configured to detect a correlation component, of the power signal, that represents a direction of change of output power relative to modulation of the control input of the power supply by the modulation signal generator. The integrator can be: coupled to the demodulator and the power supply; and configured to generate a control signal based on the correlation component, the control signal defining a voltage-step adjustment of the power supply that drives the input voltage toward a target output voltage corresponding to a maximum power point.)

In this implementation, the power regulator module 120 can thus maintain both the input isolation switch 122 and the output isolation switch 124 in their closed positions in order to output power from the solar panel to the inverter in response to authenticating a token during the current token interval. Conversely, in response to failure to receive or authenticate a token, as described above, the power regulator module 120 can trigger the input isolation switch 122 and the output isolation switch 124 to transition to their open positions in order to cease output of power from the solar panel to the inverter.

Thus, the power regulator module 120 can include both input and output isolate switches for redundant electrical isolation between the solar panel and the inverter.

### 10.4 Shunt

In one variation shown in FIG. 4, the power regulator module 120 further includes a shunt 126. Accordingly, in response to absence of receipt of the second token by the first wireless communication module 128, the power regulator module 120 can connect the shunt 126 to the power stage to dissipate residual charge in the power stage via the shunt 126.

For example, the shunt 126 can include a switched resistive element, such as a resistor, a rheostat, or a resistor network selectively connected across the power stage by a switching element (e.g., a MOSFET, an IGBT, a relay) to discharge energy (transiently) stored in the power stage during or following a shutdown event.

Thus, the power regulator module 120 can include a shunt 126 configured to dissipate residual charge in the power stage in order to: prevent residual voltage from persisting at the output terminals of the power regulator module 120 after a shutdown event, which may otherwise induce electrical stress, component damage, or unpredictable contact voltage; and ensure rapid collapse of voltage across the output terminals of the power regulator module 120 to a quiescent or near-zero potential.

In this and the foregoing implementations and as shown in FIG. 6, in response to absence of receipt of a valid token by the wireless communication module 128 or otherwise detecting a shutdown event, the power regulator module 120 can: trigger the input isolation switch 122 to transition to the open position at a first time; trigger the output isolation switch 124 to transition to the second open position at a second time succeeding the first time; and trigger the shunt 126 to electrically couple to the power stage to discharge residual charge in the power stage at a third time succeeding the second time. In particular, in this implementation, the power regulator module 120 can sequentially trigger changes of state of the input isolate switch, the output isolate switch, and the shunt 126 responsive to detecting a shutdown event. For example, during normal operation, the power regulator module 120 can maintain the input isolation switch 122 and the output isolation switch 124 in their corresponding closed positions and maintain the shunt 126 decoupled from the power stage. In response to detecting a shutdown event, the power regulator module 120 can: suspend modulation of the power supply (e.g., maximum power point tracking); trigger the input isolation switch 122 to open in order to isolate the solar panel from the power regulator module 120; then trigger the output isolation switch 124 to open to disconnect the power regulator module 120 from the inverter, such as 20 milliseconds later; and then activate the shunt circuit—coupled to the regulator circuit—to discharge residual charge stored in the regulator circuit, such as a further 20 milliseconds later. Thus, by sequentially decoupling the power regulator module 120 from the solar panel, then decoupling the power regulator module 120 from the inverter, and then coupling the shunt 126 to the power stage, the power regulator module 120 can: prevent reverse-current injection from the solar panel into the power stage or inverter; and prevent propagation of voltage transients or current surges into the inverter or adjacent power regulator modules 120 (e.g., in the same solar string) during shutdown.

### 10.5 Shutdown Validation+Logs

In one variation, the power regulator module 120 further includes a voltage sensor interposed between: the output isolation switch 124; and an output terminal of the power regulator module 120.

In this variation, in response to absence of receipt of a valid token by the wireless-communication module, the power regulator module 120 can: trigger the input-isolation switch to transition to the open position; then trigger the output-isolation switch to transition to the second open position; and then trigger the shunt 126 to electrically couple to the power stage to discharge residual charge in the power stage. The power regulator module 120 can then read an output voltage (i.e., a voltage across the power regulator module 120 and/or the corresponding solar panel) from the voltage sensor. If this output voltage approximates a quiescent voltage or is less than a threshold voltage (e.g., 0.1 volts DC), the power regulator module 120 can confirm successful shutdown. Thus, the power regulator module 120 can: verify its shutdown based on its output voltage after responding to a shutdown event; and broadcast a confirmation of successful shutdown to the hub accordingly, such as once this output voltage falls below the quiescent or threshold voltage.

However, if this output voltage exceeds the quiescent voltage or the threshold voltage for more than a threshold time duration after responding to the shutdown event, the power regulator module 120 can: detect an unsuccessful or delayed shutdown; generate a shutdown-fault flag; and transmit the shutdown-fault flag to the hub. The hub can then: trigger other power regulator modules 120 to shut down; record the shutdown-fault flag in non-volatile memory; and transmit a notification or alert to an operator (e.g., via an operator portal) responsive to receipt of this shutdown-fault flag.

Therefore, the power regulator module 120 can validate completion of its own shutdown sequence and self-report any shutdown fault conditions to the hub based on a post-shutdown voltage across its output terminals. Furthermore, the hub can: verify rapid-shutdown compliance across the solar array based on such shutdown confirmation and fault reports received from these power regulator modules 120; maintain a log (or other record) of shutdown performance across these power regulator modules 120 based on these reports; and/or generate service prompts—for power regulator modules 120 failing shutdown or the solar array more generally—based on these shutdown confirmation and fault reports and distribute these service prompts to an operator.

### 11. Shutdown Compensation

In one variation shown in FIG. 6, the first power regulator module 120 preemptively reports its planned or imminent shutdown—such as following failure to receive a valid token during a token interval—to other power regulator modules 120 in the solar array in order to enable these or other power regulator modules 120 to preemptively compensate for loss of power and voltage output by the first power regulator module 120.

In particular, the first power regulator module 120 can leverage the virtual map of the solar array or other record of power regulator module 120 connections within solar strings in the solar array to identify other power regulator modules 120 in the same solar string. Then, in response to failure to receive a valid token within the current token window, the first power regulator module 120 can generate a notification indicating its intent to shut down, such as within a specific time window or count of additional token intervals without receipt of a valid token; and then wirelessly transmit this notification to these other power regulator modules 120 in the same solar string. The first power regulator module 120 can thus selectively inform these other power regulator modules 120 in the same solar string of the first power regulator module 120's possible upcoming transition into the shutdown mode.

In one implementation, the first power regulator module 120: can be coupled to a first solar panel arranged in a first solar string in the solar array; and can broadcast a notification indicating shutdown intent to a second power regulator module 120 during a token window in response to absence of receipt of a token by the first wireless communication module 128 in the first power regulator module 120. The second power regulator module 120: can be coupled to a second solar panel in the first solar string in the solar array; and can, given presence of the first solar panel and the second solar panel in the first solar string, increase its voltage output to the inverter (or to first solar string more specifically) to compensate for planned shutdown of the first power regulator module 120 in response to receiving the shutdown intent from the first power regulator module 120.

For example, if the voltage output of the solar string is low or otherwise near a minimum string voltage at time of receipt of this notification, these other power regulator modules 120 can selectively increase their output voltages (and this reduce their power outputs and efficiencies) before the first power regulator module 120 enters the shutdown mode in order to maintain a line voltage of the solar string above the minimum string voltage if and once the first power regulator module 120 shuts down. However, if the first power regulator module 120 remains in the operating mode beyond the time duration or token window count indicated in the notification—such as responsive to subsequent receipt of a valid token within this time duration or token window count—the second power regulator module 120 can transition back to its prior (higher-efficiency) voltage or power output state.

Therefore, the first power regulator module 120 can broadcast intent of imminent shutdown to other power regulator modules 120 within the same solar string in order to enable these other power regulator modules 120 to preemptively adjust their operating voltages, such as to maintain total string voltage and inverter stability even during partial communication loss or localized shutdown at one power regulator module 120 in this solar string. Therefore, these power regulator modules 120 in one solar string can preserve continuous voltage regulation and avoid inverter drop-out in instances in which a power regulator module 120 in this solar string temporarily ceases operation due to failure to receive or validate a token.

(Conversely, if the voltage output of the solar string is near a maximum string voltage and these power regulator modules 120 are operating below their maximum power point voltages in order to avoid a string overvoltage at time of receipt of this notification from the first mod, other power regulator modules 120 in the solar string can selectively decrease their output voltages—and thus increase their power outputs and efficiencies—in order to preemptively compensate for likely loss of the first power regulator module 120.)

### 12. Power Regulator Module Reactivation

As described above and as shown in FIG. 6, the power regulator module 120 can: continue to scan for valid tokens once in the shutdown mode; and automatically rejoin power generation by the solar array, such as responsive to receiving a valid token, a sequence of valid tokens, and/or confirmation to rejoin from the hub.

Generally, a power regulator module 120 may fail to receive a valid token during a token interval despite transmission of a valid token by the hub during this token interval, such as due to electromagnetic interference, electromagnetic noise, signal collisions, or signal reflections around the solar array, and such failures may be unpredictable and affect singular or small groups of power regulator modules 120. Therefore, a power regulator module 120 can automatically rejoin power generation by the solar array—soon (e.g., within one token interval) after entering the shutdown mode—upon receiving a single valid token, thereby increasing robustness of the solar array to such electromagnetic interference, interference noise, or signal collisions, etc.

For example, after entering the shutdown mode, the power regulator module 120 can: access a token broadcast by the hub and received by the first wireless communication module 128; authenticate the token based on the instance of the site key stored in local memory 129; and trigger the switch(es) to transition to the closed position in order to output power from the first solar panel to the inverter in response to authenticating this token.

Alternatively, after entering the shutdown mode, the power regulator module 120 can: access a token broadcast by the hub and received by the first wireless communication module 128; authenticate the token based on the instance of the site key stored in local memory 129; maintain the switch(es) in the open position in order to prevent power output from the first solar panel to the inverter; and index a reactivation counter in response to authenticating this token. Subsequently, the power regulator module 120 can: access a next token broadcast by the hub and received by the first wireless communication module 128; authenticate this next token based on the instance of the site key stored in local memory 129; index the reactivation counter in response to authenticating this next token; and trigger the switch(es) to transition to the closed position in order to output power from the first solar panel to the inverter in response to the reactivation counter exceeding a threshold count. Therefore, the power regulator module 120 can implement hysteresis techniques during rejoin in order to prevent oscillation of the power regulator module 120 between shutdown and operational modes due to intermittent token reception.

### 12.1 Hub-Directed Rejoin Request

Additionally or alternatively, once in the shutdown mode, the power regulator module 120 can: continue to scan for valid tokens; and wirelessly transmit a rejoin request to the hub following receipt of one or a sequence of (e.g., three consecutive) valid tokens. The hub can then: selectively return confirmation to the power regulator module 120 to rejoin, such as based on: real time string voltage margin relative to upper and lower voltage limits of the inverter; performance (e.g., power output, voltage output, maximum power point, duty cycle) of other power regulator modules 120 in the solar array or the same solar string; and/or frequency or count of recent rejoin requests received from other power regulator modules 120 in the solar array. More specifically, the power regulator module 120 can request rejoin confirmation from the hub, and the hub can selectively confirm or time rejoin by the power regulator module 120 in order to avoid excess oscillation of total power or voltage supplied to the inverter, such as resulting from multiple concurrent or closely-occurring shutdowns and rejoins by one or more power regulator modules 120 in the solar array.

For example, after entering the shutdown mode, the power regulator module 120 can: access a token broadcast by the hub and received by the first wireless communication module 128; authenticate the token based on the instance of the site key stored in local memory 129; maintain the switch(es) in the open position in order to prevent power output from the first solar panel to the inverter; and index a reactivation counter in response to authenticating this token. Subsequently, the power regulator module 120 can: access a next token broadcast by the hub and received by the first wireless communication module 128; authenticate this next token based on the instance of the site key stored in local memory 129; index the reactivation counter in response to authenticating this next token; maintain the switch(es) in the open position in order to prevent power output from the first solar panel to the inverter; and transmit a rejoin request to the hub in response to the reactivation counter exceeding a threshold count.

In this example, upon receipt of this rejoin request from the power regulator module 120, the hub can delay confirmation of the rejoin request until no other power regulator module 120 has shut down or rejoined the solar array within a threshold time window (e.g., 30 seconds). The hub can also return confirmation of the rejoin request with a command to ramp from null power or voltage to the power regulator module 120's maximum power point, such as slowly or over at least a minimum time interval (e.g., one minute). Then, in response to receipt of confirmation from the hub—responsive to its rejoin request—via the wireless communication module 128, the power regulator module 120 can trigger the switch(es) to transition to the closed position to output power from the solar panel to the inverter.

Therefore, in this implementation, the hub can control rejoins by power regulator modules 120 following shutdown events, such as based on a greater context of the entire solar array monitored by the hub.

### 12.2 Rejoin Notifications

In a similar implementation, after entering the shutdown mode and then detecting one or a series of valid tokens and/or receiving confirmation to rejoin from the hub, a first power regulator module 120 can broadcast a rejoin notification—via its wireless communication module 128—to a second power regulator module 120 coupled to a second solar panel arranged in the same solar string in order to inform the second power regulator module 120 that the power regulator module 120 will soon or is presently increasing voltage and power output to the solar array or the solar string. The second power regulator module 120 can then: return its current operating parameters, including a maximum power point or duty cycle, to the first power regulator module 120. Upon receiving these current operating parameters from the second power regulator module 120, the first power regulator module 120 can implement these current operating parameters to rapidly converge on a peak power or peak efficiency output from its corresponding solar panel, such as by: ramping its output voltage from a quiescent voltage toward the maximum power point voltage of the second power regulator module 120; and biasing search for a first maximum power point voltage of the first power regulator module 120 around this second maximum power point voltage of the second power regulator module 120. More specifically, the first power regulator module 120 can leverage the virtual map of the solar array or other record of power regulator modules 120 occupying the same solar string in order to: selectively inform these particular power regulator modules 120 of changes of state of the first power regulator module 120 that may affect performance of the entire string; and enable these other power regulator modules 120 in the same solar string to automatically and/or preemptively handle rejoin by the first power regulator module 120—and thus avoid rapid changes in string output voltage or current that may otherwise trigger detection of new shutdown events by the hub.

Additionally or alternatively, upon receiving the rejoin notification from the first power regulator module 120, other power regulator modules 120 in the same string can prepare for imminent increase in voltage and/or power output by the first power regulator module 120, such as by partially decreasing their voltage and/or power outputs in order to avoid an over-voltage condition at the inverter as the first power regulator module 120 returns to the operational mode.

Accordingly, the power regulator modules 120 can cooperate to smooth rejoins by individual power regulator modules 120, to reduce inverter bus ripple during rejoins, and to limit transient power mismatches across a solar string.

### 13. Mesh Network+Token Passing

In one variation, power regulator modules 120 in the solar array can form a mesh network, each power regulator module 120 can wirelessly rebroadcast or handoff tokens upon receipt (i.e., from the hub or other power regulator module 120 in the solar array) in order to reduce probability or likelihood that another power regulator module 120 will inadvertently shutdown due to absence of receipt of a token. The power regulator modules 120 can thus form a mesh network to increase communication redundancy across the solar array and mitigate localized radio-frequency shadowing or path loss, such as caused by geometry of nearby solar panels or a roof structure.

More specifically, a first power regulator module 120 can: form a mesh network with a set of other power regulator modules 120 in the solar array; and rebroadcast a token in response to receipt of the token. A second power regulator module 120 can thus: access this token rebroadcast by the first power regulator module 120; authenticate this token based on its local instance of the site key; and maintain power output from its corresponding solar panel to the inverter in response to authenticating this token. A power regulator module 120 can thus function as a relay node that extends an effective wireless communication range of the hub without additional dedicated repeaters.

Furthermore, in this implementation, the hub can implement a token interval greater than a total time duration for a) the hub to generate and broadcast a new token and b) distribution of this token to all power regulator modules 120 in the solar array via the mesh network. Additionally or alternatively, the power regulator modules 120 can implement a shutdown time of length greater than this total time duration for a) the hub to generate and broadcast a new token and b) distribution of this token to all power regulator modules 120 in the solar array via the mesh network. Accordingly, the hub and power regulator modules 120 can cooperate to enforce sufficient time for each token to traverse the mesh network and to be authenticated by power regulator modules 120 before any power regulator module 120 initiates a shutdown timer or otherwise prepares to enter the shutdown mode, thereby preventing premature shutdowns due to network latency, multi-hop delays, or out-of-order message receptions while enabling the hub and the power regulator modules 120 to maintain synchronized heartbeat verification across the entire solar array.

### 14. Solar Array Reactivation

Furthermore, following shutdown of the hub and resulting shutdown of the power regulator modules 120, the hub can transition to an operational mode, such as following restoration of utility power, completion of maintenance, or reset of the inverter. In particular, as the hub returns to the operational mode, each power-regulator module in the solar array may already be in the shutdown mode due to absence of receipt of valid tokens while the hub was inactive.

Thus, as the hub returns to the operational mode, the hub can: pull sensor data from sensors throughout the solar array; process these data to verify normal operation of the solar array; and generate and broadcast tokens given normal operation of the solar array. While in this shutdown mode, each power regulator module 120 can: continue to monitor for tokens; generate and distribute a rejoin request to the hub upon receiving a target count of (e.g., three consecutive) valid tokens; and return to the operational mode upon receipt of confirmation from the hub.

Alternatively, as the hub returns to the operational mode, the hub can: pull sensor data from sensors throughout the solar array; process these data to verify normal operation of the solar array; and generate and broadcast dedicated startup tokens given normal operation of the solar array. While in this shutdown mode, each power regulator module 120 can: continue to monitor for tokens; and automatically return to the operational mode upon receipt of a dedicated startup token. Therefore, in this implementation, the hub can broadcast dedicated startup tokens when transitioning back to the operational mode in order to reduce time for the power regulator modules 120 to rejoin the solar array and decrease risk of rejoin request collisions from these power regulator modules 120.

### 15. Multiple Hubs

In another variation, the system 100 includes multiple hubs, such as one hub per solar string. In this implementation, each hub can implement the foregoing methods and techniques for its corresponding solar string, such as including: distributing a string-specific site key to power regulator modules 120 in its solar string; monitoring temperature, voltage, current, power, power variance or stability, smoke presence, etc. of its solar string; generating tokens according to its string-specific site key when its solar string is operating normally or within normal bounds; and broadcasting these tokens to power regulator modules 120 in its solar string.

For example, each hub in the solar array can operate on an independent wireless channel in order to avoid token collisions or cross-string interference. Additionally or alternatively, each hub can maintain a unique hub identifier and embed this unique hub identifier in each token it generates in order to enable the power regulator module 120 in its solar string to identify and discard tokens received from other hubs. Similarly, each hub can: implement a unique key to generate tokens for each unique power regulator module in the solar array; and thus transmit one unique token per power regulator module in its solar string during one token interval.

In this variation, the system 100 can also include a master hub coupled to the inverter, as described above. String-level hubs can transmit sensor and/or telemetry data to the master hub, both string-level and master hubs can generate and broadcast tokens, and each power regulator module 120 can transition into the shutdown mode in response to failure to receive valid tokens from both the master hub and their corresponding string-level hubs. In this dual-authority configuration, loss or failure of a string-level hub, the master hub, or a communication channel can independently trigger rapid shutdown for power regulator modules 120 in corresponding sections of (e.g., clusters of power regulator modules 120 in) the solar array while allowing power regulator modules 120 in unaffected strings to continue normal operation.

### 15.1 Other Configurations

Additionally, the system 100 can include a single hub coupled to multiple solar strings and configured to distribute a distinct site key to each solar string (i.e., to all power regulator modules within each solar string). In this configuration, the hub can selectively cease broadcast of tokens corresponding to a particular site key and to a particular solar string in order to selectively shutdown this particular solar string while maintaining operation of other solar strings in the solar array, such as to enable service or maintenance of a solar panel with the particular string without interrupting operation of power regulator modules in other solar strings in the solar array.

In yet another configuration, the system 100 can include a single hub coupled to multiple inverters, wherein each inverter is connected to one or more solar strings. Accordingly the hub can assign a unique site key to each inverter in the solar array. In this configuration, the hub can selectively shutdown all power regulator modules in all solar strings associated with (i.e., connected to) a particular inverter while maintaining operation of other power regulator modules in solar strings associated with other inverters in the solar array. Accordingly, the hub can enable expansion or contraction of the solar array by activating or deactivating generation and broadcast of tokens specific to select inverters, thereby automatically adding or removing, respectively, these inverters and their associated power regulator modules without requiring downtime for other inverter-string groups.

In these configurations in which the solar array multiple inverters and/or multiple solar strings, the hub can also: interface with inverter-specific or string-specific sensors; and selectively trigger shutdown of a particular solar string or particular inverter independently of other solar strings or inverters in the solar array based on sensor data collected from this particular solar string or particular inverter.

### 16. Conclusion

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a first power regulator module:
coupled to a first solar panel in a solar array;
comprising:
a first isolation switch operable in:
a closed position to output power from the first solar panel to an inverter; and
an open position to cease output of power from the first solar panel to the inverter;
a first wireless communication module; and
a first local memory configured to store a first site key; and
configured to:
during a first time period:
access a first token broadcast by a hub and received by the first wireless communication module;
authenticate the first token based on the first site key; and
in response to authenticating the first token:
maintain the first isolation switch in the closed position to output power from the first solar panel to the inverter; and
during a second time period:
in response to absence of receipt of a second token by the first wireless communication module:
trigger the first isolation switch to transition to the open
position to cease output of power from the first solar panel to the inverter.

2. The system of claim 1, wherein the first power regulator module is configured to:
during an intermediate time period between the first time period and the second time period:
in response to absence of receipt of a third token by the first wireless communication module:
activate a timer for a planned shutdown duration; and
maintain the first isolation switch in the closed position to output power from the first solar panel to the inverter; and
during the second time period:
in response to absence of receipt of the second token by the first wireless communication module prior to expiration of the timer:
trigger the first isolation switch to open to cease output of power from the first solar panel to the inverter.

3. The system of claim 2:
wherein the first power regulator module:
is coupled to the first solar panel arranged in a first solar string in the solar array; and
is configured to broadcast a shutdown intent to a second power regulator module during the intermediate time in response to absence of receipt of the third token by the first wireless communication module; and
further comprising the second power regulator module:
coupled to a second solar panel in the first solar string in the solar array;
comprising:
a second isolation switch operable in:
the closed position to output power from the second solar panel to an inverter; and
the open position to cease output of power from the second solar panel to the inverter;
a second wireless communication module; and
a second local memory configured to store the first site key; and
configured to:
during the first time period:
access the first token broadcast by the hub and received by the second wireless communication module;
authenticate the first token based on the first site key; and
in response to authenticating the first token:
maintain the second isolation switch in the closed position to output power from second solar panel to the inverter; and
during the intermediate time period:
access a second token broadcast by the hub and received by the second wireless communication module;
authenticate the second token based on the first site key; and
in response to authenticating the second token:
maintain the second isolation switch in the closed position to output power from second solar panel to the inverter; and
in response to receiving the shutdown intent from the first power regulator module and based on presence of the first solar panel and the second solar panel in the first solar string:
increase a voltage output of the second power regulator module to the inverter to compensate for planned shutdown of the first power regulator module.

4. The system of claim 1:
wherein the first power regulator module is configured to:
form a mesh network with a set of power regulator modules in the solar array;
rebroadcast the first token during the first time period in response to receipt of the first token; and
further comprising a second power regulator module, in the set of power regulator modules:
coupled to a second solar panel in the solar array;
comprising:
a second isolation switch operable in:
the closed position to output power from the second solar panel to an inverter; and
the open position to cease output of power from the second solar panel to the inverter;
a second wireless communication module; and
a second local memory configured to store the first site key; and
configured to:
during the first time period:
access the first token rebroadcast by the first power regulator module and received by the second wireless communication module;
authenticate the first token based on the first site key; and
in response to authenticating the first token:
maintain the second isolation switch in the closed position to output power from second solar panel to the inverter.

5. The system of claim 1:
wherein the first power regulator module comprises a first power stage;
wherein the first isolation switch comprises an input isolation switch operable in:
the closed position to couple an output of the first solar panel to the first power stage of the first power regulator module; and
an open position to decouple the output of the first solar panel from the first power stage of the first power regulator module; and
wherein the first power regulator module:
further comprises an output isolation switch operable in:
a second closed position to couple the first power stage of the first power regulator module to the inverter; and
a second open position to decouple the first power stage of the first power regulator module from the inverter; and
is configured to:
during the first time period:
in response to authenticating the first token:
maintain the first isolation switch in the closed position and the output isolation switch in the second closed position to output power from the first solar panel to the inverter; and
during the second time period:
in response to absence of receipt of the second token by the first wireless communication module:
trigger the first isolation switch to transition to the open position and trigger the output isolation switch to transition to the second open position to cease output of power from the first solar panel to the inverter.

6. The system of claim 5, wherein the first power regulator module:
further comprises a shunt coupled to the power stage; and
is configured to:
during the second time period:
in response to absence of receipt of the second token by the first wireless communication module:
dissipate residual charge in the power stage via the shunt.

7. The system of claim 6, wherein the first power regulator module:
comprises a voltage sensor interposed between the output isolation switch and a power output terminal of the first power regulator module; and
is configured to, during the second time period:
in response to absence of receipt of the second token by the first wireless communication module:
at a first time, trigger the first isolation switch to transition to the open position;
at a second time succeeding the first time, trigger the output isolation switch to transition to the second open position;
at a third time succeeding the second time, trigger the shunt to electrically couple to the power stage to discharge residual charge in the power stage;
at a fourth time succeeding the third time, read an output voltage from the voltage sensor; and
in response to the output voltage exceeding a threshold voltage, generate a shutdown fault flag.

8. The system of claim 5, wherein the first power regulator module comprises:
a power supply configured to:
receive an input voltage generated by the first solar panel via the first isolation switch; and
generate an output voltage;
a modulation signal generator:
coupled to the power supply; and
configured to modulate a control input of the power supply to vary a voltage gain from the input voltage to the output voltage;
a detector:
coupled to the power supply and the modulation signal generator; and
configured to characterize a power signal output by the power supply responsive to modulation of the control input of the power supply by the modulation signal generator;
a demodulator:
coupled to the detector; and
configured to detect a correlation component, of the power signal, that represents a direction of change of output power relative to modulation of the
control input of the power supply by the modulation signal generator; and
an integrator:
coupled to the demodulator and the power supply; and
configured to generate a control signal based on the correlation component, the control signal defining a voltage-step adjustment of the power supply that drives the input voltage toward a target output voltage corresponding to a maximum power point.

9. The system of claim 1, wherein the first power regulator module is configured to:
during a third time period succeeding the second time period:
access a third token broadcast by the hub and received by the first wireless communication module;
authenticate the third token based on the first site key; and
in response to authenticating the third token:
trigger the first isolation switch to transition to the closed position to output power from the first solar panel to the inverter.

10. The system of claim 9, wherein the first power regulator module is configured to:
during an intermediate time period between the second time period and the third time period:
access a fourth token broadcast by the hub and received by the first wireless communication module;
authenticate the fourth token based on the first site key; and
in response to authenticating the fourth token:
index a reactivation counter; and
during the third time period:
in response to authenticating the third token:
index a rejoin counter;
in response to the rejoin counter exceeding a threshold count:
broadcast a rejoin request, via the first wireless communication module, to the hub; and
in response to receipt of confirmation from the hub, responsive to the rejoin request, by the first wireless communication module:
trigger the first isolation switch to transition to the closed position to output power from the first solar panel to the inverter.

11. The system of claim 9, wherein the first power regulator module:
is coupled to the first solar panel arranged in a first solar string in the solar array; and
is configured to:
during the third time period:
in response to authenticating the third token:
broadcast a rejoin notification, via the first wireless communication module, to a second power regulator module coupled to a second solar panel arranged in the first solar string; and
receive a second maximum power point voltage of the second power regulator module during the third time period, returned by the second power regulator module responsive to the rejoin notification, via the first wireless communication module; and
during a fourth time period succeeding the third time period:
ramp an output voltage of the first power regulator module from a quiescent voltage toward the second maximum power point voltage; and
bias search for a first maximum power point voltage of the first power regulator module around the second maximum power point voltage of the second power regulator module.

12. The system of claim 1:
wherein the first power regulator module is coupled to the first solar panel arranged in a first solar string in the solar array;
further comprising the hub:
coupled to the first solar string; and
configured to:
during the first time period:
detect nominal operation of the first solar string; and
in response to detecting nominal operation of the first solar string:
broadcast the first token; and
during the second time period:
detect deviation of the first solar string from nominal operation; and
in response to detecting deviation of the first solar string from nominal operation:
cease broadcast of tokens;
wherein the first local memory is configured to store the first site key issued by the hub to power regulator modules in the first solar string; and
further comprising:
a second hub:
coupled to a second solar string in the solar array; and
configured to:
during the first time period:
detect nominal operation of the second solar string; and
in response to detecting nominal operation of the second solar string:
broadcast a third token; and
a second power regulator module:
coupled to a second solar panel arranged in the second solar string in the solar array;
comprising:
a second isolation switch operable in:
the closed position to output power from the second solar panel to the inverter; and
the open position to cease output of power from the second solar panel to the inverter;
a second wireless communication module; and
a second local memory configured to store a second site key different from the first site key and issued by the second hub to power regulator modules in the solar string; and
configured to:
during the first time period:
access the third token broadcast by the second hub and received by the second wireless communication module;
authenticate the third token based on the second site key; and
in response to authenticating the third token:
maintain the second isolation switch in the closed position to output power from second solar panel to the inverter.

13. The system of claim 1, further comprising the hub:
coupled to the solar array; and
configured to:
during the first time period:
detect nominal operation of the solar array; and
in response to detecting nominal operation of the solar array:
broadcast a series of tokens, comprising the first token, at target time interval; and
during the second time period:
detect deviation of the solar array from nominal operation; and
in response to detecting deviation of the solar array from nominal operation:
cease broadcast of tokens.

14. The system of claim 13, wherein the first power regulator module is configured to:
during the second time period:
in response to absence of receipt of the second token by the first wireless communication module within a time window, of duration greater than the target time interval, since authentication of a last token received by the wireless communication module:
trigger the first isolation switch to transition to the open position to cease output of power from the first solar panel to the inverter.

15. The system of claim 13, wherein the hub is configured to:
during the first time period:
access a bus voltage detected by a voltage sensor coupled to the inverter; and
detect nominal operation of the solar array in response to the bus voltage falling within a nominal operating voltage range; and
during the second time period:
access the bus voltage detected by the voltage sensor; and
detect deviation of the solar array from nominal operation in response to the bus voltage falling outside of the nominal operating voltage range.

16. The system of claim 13, wherein the hub is configured to:
during the first time period:
access a first timeseries of bus voltages detected by a voltage sensor coupled to the inverter;
extract a first alternating-current component from the first timeseries of bus voltages; and
detect nominal operation of the solar array in response to the first alternating-current component exhibiting a first frequency within a nominal ripple-band corresponding to electrical stability of the solar array; and
during the second time period:
access a second timeseries of bus voltages detected by the voltage sensor;
extract a second alternating-current component from the second timeseries of bus voltages; and
detect deviation of the solar array from nominal operation in response to the second alternating-current component exhibiting a second frequency outside of the nominal ripple-band.

17. The system of claim 13, wherein the hub is configured to:
during the first time period:
access a smoke signal from a smoke detector proximal the solar array; and
detect nominal operation of the solar array in response to the smoke signal indicating absence of smoke proximal the smoke detector; and
during the second time period:
access the smoke signal from the smoke detector; and
detect deviation of the solar array from nominal operation in response to the smoke signal indicating presence of smoke proximal the smoke detector.

18. The system of claim 13:
further comprising the hub:
coupled to the solar array; and
configured to:
during a setup period preceding first time period:
broadcast an identification query;
wherein the first power regulator module is configured to:
return a first identifier of the first power regulator module to the hub in response to receipt of the identification query from the hub; and
wherein the hub is configured to:
during the setup period:
in response to receipt of the first identifier from the first power regulator module responsive to the identification query:
populate a solar array manifest with the first identifier; and
return the first site key, associated with the solar array, to the first power regulator module.

19. A system comprising:
a hub:
coupled to a solar array; and
configured to:
during a first time period:
detect nominal operation of the solar array; and
in response to detecting nominal operation of the solar array:
broadcast a first token; and
during a second time period:
detect deviation of the solar array from nominal operation; and
in response to detecting deviation of the solar array from nominal operation:
cease broadcast of tokens; and
a first power regulator module:
coupled to a first solar panel in the solar array;
comprising:
a first isolation switch operable in:
a closed position to output power from the first solar panel to an inverter; and
an open position to cease output of power from the first solar panel to the inverter; and
a first wireless communication module; and
configured to:
during the first time period:
receive the first token, broadcast by the hub, via the first wireless communication module;
authenticate the first token; and
in response to authenticating the first token:
maintain the first isolation switch in the closed position to output power from the first solar panel to the inverter; and
during a second time period:
in response to absence of receipt of a second token by the first wireless communication module:
trigger the first isolation switch to transition to the open position to cease output of power from the first solar panel to the inverter.

20. A method comprising:
at a hub coupled to a solar array:
during a first time period:
detecting nominal operation of the solar array; and
in response to detecting nominal operation of the solar array:
broadcasting a first token; and
during a second time period:
detecting deviation of the solar array from nominal operation; and
in response to detecting deviation of the solar array from nominal operation:
withholding broadcast of tokens; and
at a first power regulator module coupled to a first solar panel in the solar array:
during the first time period:
receiving the first token broadcast by the hub;
authenticating the first token;
in response to authenticating the first token:
maintaining a first isolation switch, coupled to an output terminal of the first power regulator module, in a closed position to output power from the first solar panel to an inverter; and
during a second time period:
in response to absence of receipt of a second token broadcast by the hub:
triggering the first isolation switch to transition to an open position to cease output of power from the first solar panel to the inverter.
